(19) United States
(12) Patent Application Publication
(10) Pub. No.: US 2024/0264545 A1
(43) Pub. Date: Aug. 8, 2024

(54) TONER

(71) Applicant: CANON KABUSHIKI KAISHA, Tokyo (JP)

(72) Inventors: ATSUHIKO OHMORI, Kanagawa (JP); TOMOHISA SANO, Shizuoka (JP); KOSUKE FUKUDOME, Tokyo (JP); TOHRU HIRAMATSU, Shizuoka (JP); HIROKI KAGAWA, Shizuoka (JP); KAZUYUKI SATO, Kanagawa (JP)

(21) Appl. No.: 18/418,782

(22) Filed: Jan. 22, 2024

(30) Foreign Application Priority Data
Jan. 26, 2023 (JP) 2023-010020

(51) Int. Cl. G03G 9/097; G03G 9/08; G03G 9/093

(52) U.S. Cl. CPC G03G 9/09725; G03G 9/0819; G03G 9/09328; G03G 9/0975

(57) ABSTRACT

To provide a toner that is less likely to cause image defects due to the detachment of the silica aggregated particle even when having been used for a long period of time in a low-temperature and low-humidity environment. The toner includes: a toner particle containing a binder resin; and a silica aggregated particle, wherein, in TOF-SIMS measurement of the toner particle, a fragment peak derived from a boron atom and a fragment peak derived from a boron-oxygen structure are detected; the silica aggregated particle is an aggregated particle of silica fine particles having a primary particle size based on number of from 20 to 75 nm, a maximum Feret's diameter of the silica aggregated particle is from 110 to 500 nm, and an aspect ratio thereof is from 1.50 to 4.00.

### BACKGROUND OF THE INVENTION

### Field of the Invention

The present invention relates to a toner used in an electrophotographic image forming apparatus.

### Description of the Related Art

In general, an electrophotographic method is a method of using a photoconductive substance, forming a latent image on an image carrier (photoreceptor), developing the electrostatic latent image with a toner to visualize the latent image, transferring a toner image on the photoreceptor to a recording medium such as paper as needed, and fixing the toner image on the recording medium by heat, pressure, heat and pressure or the like to obtain a copy or a print. At this time, the toner which has not been transferred to the recording medium after the transfer and has remained on the photoreceptor is cleaned by various methods.

In the above transfer step of transferring the toner image on the photoreceptor to the recording medium, a contact transfer method has been proposed which performs the transfer by a structure of pressing the toner image on the photoreceptor against the recording medium. In such a contact transfer method, in order to faithfully draw a toner image on a photoreceptor on a recording medium, it is important to appropriately charge the toner and also to suppress a decrease in the fluidity of the toner.

In other words, in a transfer nip portion at which a photoreceptor and a transfer member in the contact transfer method come in contact with each other, when a toner image on the photoreceptor is pressed by the transfer member, the toner becomes a state of easily adhering to the photoreceptor, and when the degree of adhesion is strong, there is a case where an image defect occurs. The above image defect is remarkably observed in a line image, and is called as “transfer dropout” because a part of the line is lost (mainly, at the center portion), which is a problem in improving an image quality.

In addition, in recent years, printers have begun to be used in places other than ordinary office environments, and a requirement has also been enhanced for a performance of continuing to provide high-quality images in harsh environments until the end of the product life, in other words, for a longer life.

In order to satisfy these requirements, toners are required to have such durability as to be capable of outputting a high-quality image even when having been used for a long period of time.

Conventionally, for the purpose of improving the durability, a toner has been investigated in which an aggregated silica fine particle (hereinafter, referred to as silica aggregated particle) is added to a toner particle. The silica aggregated particle can reduce an adhesive force to various members with a small amount of addition due to a spacer effect. In addition, the silica aggregated particle has projections and depressions, accordingly, is less likely to be embedded in the toner particle than a silica fine particle that does not cause aggregation, and can improve the durability. On the other hand, when the silica aggregated particle is added, there is a case where the silica aggregated particle is detached from the surface of the toner particle when the toner is rubbed, and when the toner is used for a long period of time, there has been a case where a concentration of the silica aggregated particle increases in a storage container. In particular, when the toner is used for a long period of time in a low-temperature and low-humidity environment (15° C. and 10%) in which embedding of the external additive tends to be easily suppressed, the above phenomenon becomes remarkable.

When the concentration of the silica aggregated particle increases in the storage container due to the detachment of the silica aggregated particle, the fluidity of the toner decreases because the silica aggregated particle has low rolling properties on the surface of the toner particles.

As a result, when the toner containing the silica aggregated particle is used for a long period of time in a low-temperature and low-humidity environment, the durability is improved, but the transfer dropout has been worsened due to the detachment of the silica aggregated particle.

For this reason, a toner is investigated in which a moisture adsorption amount and a shape of the silica aggregated particle are improved, as a method of improving the suppression of the transfer dropout of the toner containing the silica aggregated particle. In Japanese Patent Application Laid-Open No. 2015-1721, a toner is proposed to which a silica aggregated particle having an optimized pore volume is added, for a purpose of adjusting the moisture adsorption amount. In Japanese Patent Application Laid-Open No. 2018-45112, a toner is proposed to which a silica aggregated particle has been added and of which a shape is optimized, for the purpose of suppressing rolling on the surface of the toner particle.

As a result of investigation by the present inventors, it is considered that the toner described in Japanese Patent Application Laid-Open No. 2015-1721 increases an adhesive force to a toner in a low-temperature and low-humidity environment, by addition of a silica aggregated particle of which the pore volume has been optimized. However, as a result of the investigation by the present inventors, it has been found that when the toner has been used for a long period of time in a low-temperature and low-humidity environment, the toner cannot sufficiently suppress the detachment of the silica aggregated particle. As a result, a concentration of the silica aggregated particle increases in the storage container, and thereby, the fluidity of the toner decreases. In other words, it has been found that there is a problem of the transfer dropout which is caused by the detachment of the silica aggregated particle at the time when the toner has been used for a long period of time in a low-temperature and low-humidity environment.

On the other hand, it is considered that the toner described in Japanese Patent Application Laid-Open No. 2018-45112 increases the adhesive force to the toner by optimization of its shape. However, as in Patent Document 1, it has been found that when the toner has been used for a long period of time in a low-temperature and low-humidity environment, the toner cannot sufficiently suppress the detachment of the silica aggregated particle. As a result, a concentration of the silica aggregated particle increases in the storage container, and thereby, the fluidity of the toner decreases. In other words, it has been found that there is a problem of the transfer dropout which is caused by the detachment of the silica aggregated particle at the time when the toner has been used for a long period of time in a low-temperature and low-humidity environment.

For this reason, an object of the present invention is to provide a toner that is less likely to cause the image defect due to the detachment of the silica aggregated particle even when having been used for a long period of time in a low-temperature and low-humidity environment.

### SUMMARY OF THE INVENTION

The present invention relates to a toner that comprises: a toner particle comprising a binder resin; and a silica aggregated particle, wherein, in TOF-SIMS measurement of the toner particle, a fragment peak derived from a boron atom and a fragment peak derived from a boron-oxygen structure are detected; the silica aggregated particle is an aggregated particle of silica fine particles having a primary particle size based on number of from 20 to 75 nm, a maximum Feret's diameter of the silica aggregated particle is from 110 to 500 nm, and an aspect ratio of the silica aggregated particle is from 1.50 to 4.00; and when the silica aggregated particle is dispersed in a solvent and a titration operation is performed with the use of an aqueous solution of NaOH, the following Expression (1) is satisfied:

0.01≤[(a−b)×c×NA]/(d×e)≤0.20 (1),

(wherein a is a titration amount (L) of an aqueous solution of NaOH necessary for adjusting a mixed liquid of 25.0 g of ethanol and 75.0 g of an aqueous solution of 20% by mass of NaCl in which the silica aggregated particle is dispersed, to pH 9, b is a titration amount (L) of the aqueous solution of NaOH necessary for adjusting a mixed liquid of 25.0 g of ethanol and 75.0 g of the aqueous solution of 20% by mass of NaCl, to pH 9, c is a concentration (N) of the aqueous solution of NaOH used for the titration, NA is Avogadro's number, d is a mass (g) of the silica aggregated particle, and e is a BET specific surface area (nm²/g) of the silica aggregated particle).

Further features of the present invention will become apparent from the following description of exemplary embodiments.

### DESCRIPTION OF THE EMBODIMENTS

The description “XX or more and YY or less” or “from XX to YY” representing a numerical range means a numerical range including a lower limit and an upper limit that are end points unless otherwise stated.

### BACKGROUND OF THE INVENTION

The present inventors have conducted intensive studies on a toner containing the silica aggregated particle, which can suppress the detachment of the silica aggregated particle and can continuously provide a high-quality image, even when images have been output for a long period of time in a low-temperature and low-humidity environment.

Up to now, as an approach for suppressing the detachment of the silica aggregated particle from the toner particle, a toner has been investigated in which the moisture adsorption amount and the shape of the silica aggregated particle is optimized. Due to the optimization of the moisture adsorption amount of the silica aggregated particle, the adhesive force to the toner can be increased, and accordingly, the detachment of the silica aggregated particle can be suppressed. In addition, due to the optimization of the shape of the silica aggregated particle, the adhesive force to the toner can be increased, and accordingly, the detachment of the silica aggregated particle can be suppressed.

However, when the detachment of the silica aggregated particle is considered, at the time when images have been output for a long period of time in a low-temperature and low-humidity environment, there has been a case where the silica aggregated particle is detached when the toner has been rubbed. In particular, a silica aggregated particle having a large particle size forms a salient on the surface of the toner particle, and the height of the salient from the surface of the toner particle is increased, and accordingly, the silica aggregated particle tends to be detached when the toner is rubbed. Thereby, when images have been output for a long period of time in a low-temperature and low-humidity environment, the silica aggregated particle is detached, and thereby, a concentration of the silica aggregated particle in the storage container increases. When the concentration of the silica aggregated particle in the storage container increases, the fluidity of the toner decreases because the silica aggregated particle has low rolling properties on the surface of the toner particle. The toner having a reduced fluidity is in a state in which the toner is likely to adhere to the photoreceptor when the toner image on the photoreceptor is pressed by the transfer member at a transfer nip portion at which the photoreceptor and the transfer member come in contact with each other, and the transfer dropout has occurred.

In other words, in a toner to which the silica aggregated particle is added as is disclosed in Japanese Patent Application Laid-Open No. 2015-1721 and Japanese Patent Application Laid-Open No. 2018-45112, the adhesiveness of the silica aggregated particle to the surface of the toner particle is insufficient, and accordingly, when the toner has been used for a long period of time in a low-temperature and low-humidity environment, the silica aggregated particle is detached, and the transfer dropout has occurred.

As a result of intensive studies, the present inventors have found that a toner containing a silica aggregated particle according to the following constitution can continuously provide a high-quality image even when images have been output for a long time in a low-temperature and low-humidity environment.

That is, the toner of the present invention comprises: a toner particle comprising a binder resin; and a silica aggregated particle, wherein, in TOF-SIMS measurement of the toner particle, a fragment peak derived from a boron atom and a fragment peak derived from a boron-oxygen structure are detected; the silica aggregated particle is an aggregated particle of silica fine particles having a primary particle size based on number of from 20 to 75 nm, a maximum Feret's diameter of the silica aggregated particle is from 110 to 500 nm, and an aspect ratio of the silica aggregated particle is from 1.50 to 4.00; and when the silica aggregated particle is dispersed in a solvent and a titration operation is performed with the use of an aqueous solution of NaOH, the following Expression (1) is satisfied:

$$\\ \begin{matrix}0.01 \leq [ ( a - b ) \times c \times NA ] / ( d \times e ) \leq 0.2 , & ( 1 )\end{matrix}$$

(wherein a is a titration amount (L) of an aqueous solution of NaOH necessary for adjusting a mixed liquid of 25.0 g of ethanol and 75.0 g of an aqueous solution of 20% by mass of NaCl in which the silica aggregated particle is dispersed, to pH 9, b is a titration amount (L) of the aqueous solution of NaOH necessary for adjusting a mixed liquid of 25.0 g of ethanol and 75.0 g of the aqueous solution of 20% by mass of NaCl, to pH 9, c is a concentration (N) of the aqueous solution of NaOH used for the titration, NA is Avogadro's number, d is a mass (g) of the silica aggregated particle, and e is a BET specific surface area (nm²/g) of the silica aggregated particle).

### Mechanism by which the Present Invention Exerts its Effects

The reason will be described why the above described performances can be imparted by the combination of a toner particle having a boron-oxygen bond (BO bond) in the toner surface layer and a silica aggregated particle which controls its primary particle size, maximum Feret's diameter, aspect ratio and silanol amount.

The present inventors have found that in the toner containing the silica aggregated particle, in order to suppress the detachment of the silica aggregated particle from the toner particle when the toner has been used in a low-temperature and low-humidity environment for a long period of time, the following points are important:
(1-1) electrostatic interaction works between the silanol of the silica aggregated particle and the surface of the toner particle, and the adhesiveness of the silica aggregated particle is improved; and
(1-2) the silica aggregated particle has a flat shape, and a contact area with the toner particle surface increases; and thereby, the adhesiveness of the silica aggregated particle is improved.

The above (1-1) is strongly influenced by the silanol amount of the silica aggregated particle and the BO bond in the toner surface layer. The silanol of the silica aggregated particle is a basic substance and has polarity.

In addition, the BO bond in the toner surface layer has a polarity due to polarization. Because of this, an electrostatic interaction acts between the silanol of the silica aggregated particle and the BO bond of the surface layer of the toner particle. As a result, the adhesiveness of the silica aggregated particle is enhanced, and the detachment of the silica aggregated particle can be suppressed; and accordingly, even when images have been output for a long time in a low-temperature and low-humidity environment, the transfer dropout becomes less likely to occur.

On the other hand, the above (1-2) is strongly influenced by the primary particle size, the maximum Feret's diameter and the aspect ratio of the silica aggregated particle. Among these characteristics, the influence of the aspect ratio is large, and when the aspect ratio of the silica aggregated particle is controlled to be high, the silica aggregated particle can be formed into a flat shape. As a result, the contact area with the surface of the toner particle increases, and the adhesiveness to the toner particle can be enhanced. In addition, when the contact area between the silica aggregated particle and the surface of the toner particle increases, the improvement of the electrostatic interaction in the above (1-1) can also be expected, which acts between the silica aggregated particle and the surface of the toner particle. Because of this, even when images have been output for a long time in a low-temperature and low-humidity environment, the transfer dropout becomes less likely to occur.

As described above, only when the above (1-1) and (1-2) are satisfied, the image defect can be suppressed which is caused by the detachment of the silica aggregated particle, even in a case where images have been output for a long time under the low-temperature and low-humidity environment.

### Constitution of the Present Invention

Specifically, in order that the electrostatic interaction develops between the silica aggregated particle and the BO bond contained in the toner surface layer, the following points need to be satisfied. In other words, it is necessary that a fragment peak derived from a boron atom and a fragment peak derived from a BO structure are detected in the TOF-SIMS measurement of the toner particle, and that the silanol amount defined by the following Expression (1) satisfies the Expression (1), when the silica aggregated particle is subjected to a titration operation with an aqueous solution of NaOH. It is preferable that the silanol amount defined by the following Expression (1) when the silica aggregated particle has been subjected to the titration operation with an aqueous solution of NaOH is from 0.07 to 0.15.

0.01≤[(a−b)×c×NA]/(d×e)≤0.20 (1),

(wherein a is a titration amount (L) of an aqueous solution of NaOH necessary for adjusting a mixed liquid of 25.0 g of ethanol and 75.0 g of an aqueous solution of 20% by mass of NaCl in which the silica aggregated particle is dispersed, to pH 9, b is a titration amount (L) of the aqueous solution of NaOH necessary for adjusting a mixed liquid of 25.0 g of ethanol and 75.0 g of the aqueous solution of 20% by mass of NaCl, to pH 9, c is a concentration (N) of the aqueous solution of NaOH used for the titration, NA is Avogadro's number, d is a mass (g) of the silica aggregated particle, and e is a BET specific surface area (nm²/g) of the silica aggregated particle).

The TOF-SIMS can qualitatively measure a region of 10 nm or less from the surface of the toner. As for the presence or absence of the BO bond, sodium tetraborate decahydrate (produced by Fuji Film Wako Pure Chemical Corporation) is subjected to TOF-SIMS for the silica aggregated particle as a standard sample, in advance. Concerning the measured data, peak positions derived from the boron atom and BO₂ (typical structure having BO bond) are confirmed, in advance. After that, the target toner is subjected to the TOF-SIMS measurement, and thereby, the presence or absence of the boron atom and the BO bond can be known. When there are peaks of the boron atom and the BO bond, the electrostatic interaction can be functioned between the boron atom and BO bond and the silanol of the silica aggregated particle. Because of this, even when the toner has been used for a long period of time in a low-temperature and low-humidity environment, the transfer dropout can be suppressed which is caused by the detachment of the silica aggregated particle.

The technique for incorporating the BO bond into the surface layer of the toner particle is not particularly limited, but for example, boric acid can be incorporated into the toner particle, by internal addition of boric acid to the toner particle, or usage of boric acid as an aggregating agent in an aggregation method. Due to the addition of the boric acid as the aggregating agent, the boric acid tends to become easily introduced into the vicinity of the surface of the toner particle. At a stage in which a boric-acid-containing substance is used as a raw material, the raw material may be used in a form of organic boric acid, a borate, a borate ester or the like. When the toner particle is produced in an aqueous medium, it is preferable to add the boric acid as a borate from the viewpoint of reactivity and production stability, and specific examples thereof include sodium tetraborate and ammonium borate, and in particular, borax is preferably used.

Borax is indicated by decahydrate of sodium tetraborate (Na₂B₄O₇), and changes into boric acid in an acidic aqueous solution; and accordingly, when boric acid is used in an acidic environment in an aqueous medium, borax is preferably used.

A fact that the silanol amount in the silica aggregated particle is in the range of the above Expression (1) means that the silanol amount on the surface of the silica aggregated particle is small, but a small amount of silanol remains. Because of this, while the silica aggregated particle has hydrophobicity, an electrostatic interaction acts between the remaining silanol and the BO bond contained in the surface of the toner particle. Because of this, even when the toner has been used in a low-temperature and low-humidity environment for a long period of time, the detachment of the silica aggregated particle can be suppressed, and the transfer dropout can be suppressed.

When the silanol amount of the silica aggregated particle defined by the above Expression (1) is smaller than 0.01, the amount of silanol remaining on the surface of the silica aggregated particle is too small, and accordingly the electrostatic interaction decreases which acts between the silanol and boron on the surface of the toner particle. As a result, the adhesiveness of the silica aggregated particle to the toner particle decreases, and thereby, the suppression of the transfer dropout is worsened.

When the silanol amount defined by the above Expression (1) in the silica aggregated particle is larger than 0.20, the amount of silanol remaining on the surface of the silica aggregated particle becomes excessive, and accordingly, the hydrophobicity of the silica aggregated particle decreases, and electrostatic chargeability tends to easily become excessive. The toner containing such a silica aggregated particle tends to be easily triboelectrically charged by a stirring blade or the like in the storage container, and is electrostatically aggregated by an image force, and the charge distribution tends to be easily broadened. As a result, the suppression of fogging is worsened that is a phenomenon in which the toner is developed on a white ground portion on a recording medium, in a low-temperature and low-humidity environment.

The silanol amount on the surface of the silica aggregated particle can be controlled by the type of the treatment agent and the amount of the treatment agent to be used for the hydrophobization of the surface of the silica aggregated particle, and the treatment temperature and the treatment time period at the time of the hydrophobization treatment.

In addition, the silanol amount on the surface of the silica aggregated particle can also be controlled by a ratio of a hydrogen gas concentration and an oxygen gas concentration to silicon tetrachloride, in a flame hydrolysis step that will be described in a method for producing a silica aggregated particle, which will be described later. In other words, the hydrolysis of silicon tetrachloride can be completed by enhancing the ratio of the hydrogen gas concentration and the oxygen gas concentration to silicon tetrachloride in the flame hydrolysis step. As a result, even when the surfaces of the silica aggregated particle have been subjected to the hydrophobic treatment, a small amount of silanol can be left.

In addition, the silica aggregated particle is an aggregated particle of silica fine particles having a primary particle size based on number of from 20 to 75 nm.

The primary particle size of the silica aggregated particle based on number being within the above range means that the primary particle size of the silica fine particles constituting the silica aggregated particle is large, and that the number of silica fine particles constituting the silica aggregated particle is small. Due to the reduction of the number of silica fine particles constituting the silica aggregated particle, the number of bonding points of the silica fine particles can be reduced which are contained in the silica aggregated particle. Because of this, the impact resistance of the silica aggregated particle can be improved, and the silica aggregated particle can be prevented from being cracked, even when the toner has been rubbed by a stirring blade or the like in the storage container. Because of this, even when the toner has been used in a low-temperature and low-humidity environment for a long period of time, the embedding of the silica aggregated particle can be suppressed, and accordingly, the suppression of the transfer dropout is improved.

When the primary particle size of the silica aggregated particle based on number is smaller than 20 nm, the number of silica fine particles constituting the silica aggregated particle becomes excessive, and accordingly, the silica aggregated particle tends to become easily cracked when the toner has been rubbed by a stirring blade or the like in a storage container. When the toner containing such a silica aggregated particle is used for a long period of time in a low-temperature and low-humidity environment, the silica aggregated particle is embedded, and thereby, the suppression of the transfer dropout is worsened.

When the primary particle size of the silica aggregated particle based on number is larger than 75 nm, the number of silica fine particles constituting the silica aggregated particle becomes excessively small, and accordingly, it becomes difficult to control the silica aggregated particle to a flat shape. In the toner to which such a silica aggregated particle is added, the adhesiveness of the silica aggregated particle to the toner particle decreases. As a result, when the toner has been used in a low-temperature and low-humidity environment for a long period of time, the suppression of the transfer dropout is worsened which is caused by the detachment of the silica aggregated particle.

The silica aggregated particle also needs to have the maximum Feret's diameter of from 110 to 500 nm, and is preferably from 120 to 400 nm.

The fact that the maximum Feret's diameter of the silica aggregated particle is in the above range means that the silica aggregated particle has an appropriately large particle size. The toner containing the silica aggregated particle having the maximum Feret's diameter in the above range can reduce the adhesive force of the toner to various members by the spacer effect. In addition, the height of the salient can be suppressed which is formed when the silica aggregated particle has adhered to the surface of the toner particle, and accordingly, even when the toner has been used for a long period of time in a low-temperature and low-humidity environment, the transfer dropout can be suppressed which is caused by the detachment of the silica aggregated particle.

When the maximum Feret's diameter of the silica aggregated particle is smaller than 110 nm, the silica aggregated particle is embedded in the toner when the toner has been used in a low-temperature and low-humidity environment for a long period of time. When the toner containing such a silica aggregated particle has been used for a long period of time in a low-temperature and low-humidity environment, and when the toner is pressed against the photoreceptor at the transfer nip portion, a part of the toner adheres to the photoreceptor, and thereby, the suppression of the transfer dropout is worsened.

When the maximum Feret's diameter of the silica aggregated particle is larger than 500 nm, the height of the salient increases which is formed when the silica aggregated particle has adhered to the surface of the toner particle, and accordingly, the silica aggregated particle is detached when the toner has been rubbed in the storage container. When the toner containing such a silica aggregated particle has been used for a long period of time in a low-temperature and low-humidity environment, the suppression of the transfer dropout is worsened which is caused by the detachment of the silica aggregated particle.

Furthermore, the aspect ratio of the silica aggregated particle needs to be from 1.50 to 4.00, and is preferably from 1.70 to 3.85.

The fact that the aspect ratio of the silica aggregated particle is in the above range means that the silica aggregated particle has a flat shape. Thereby, the contact area between the silica aggregated particle and the toner particle increases. In addition, the height of the salient can be suppressed which is formed when the silica aggregated particle has adhered to the surface of the toner particle, and accordingly, the transfer dropout can be suppressed which is caused by the detachment of the silica aggregated particle, when the toner has been used for a long period of time in a low-temperature and low-humidity environment.

When the aspect ratio of the silica aggregated particle is smaller than 1.50, the silica aggregated particle becomes close to a spherical shape, and accordingly, the contact area between the silica aggregated particle and the toner particle decreases. When the toner containing such a silica aggregated particle has been used for a long period of time in a low-temperature and low-humidity environment, the suppression of the transfer dropout is worsened which is caused by the detachment of the silica aggregated particle.

When the aspect ratio of the silica aggregated particle is larger than 4.00, the silica aggregated particle has a rod shape, and accordingly, the silica aggregated particle becomes to cover the surface of the toner particle. In the toner containing such a silica aggregated particle, the electrostatic chargeability on the surface of the toner particle tends to easily become excessive, the toner particle is electrostatically aggregated by the image force, and the charge distribution tends to easily become broad. As a result, the suppression of fogging is worsened that is a phenomenon in which the toner is developed on a white character portion on a recording medium, in a low-temperature and low-humidity environment.

In the toner of the present invention, the abundance (based on mass) of a boron atom in the toner measured by an inductively coupled plasma mass spectrometry apparatus (ICP-MS) is preferably from 0.01 to 2.00 ppm, more preferably from 0.05 to 1.50 ppm.

When the abundance of the boron atom on the surface of the toner particle is controlled to be in the above range, an effect of the electrostatic interaction with the silanol of the silica aggregated particle is enhanced. Thereby, the adhesiveness of the silica aggregated particle to the toner particle is improved. As a result, even when the toner has been used in a low-temperature and low-humidity environment for a long period of time, the transfer dropout can be suppressed which is caused by the detachment of the silica aggregated particle. For information, a specific measurement method by the above apparatus will be described later.

In the present invention, it is preferable that a coverage of the toner particle with the silica aggregated particle is from 0.5% to 10.0%.

When the coverage of the silica aggregated particle is controlled to be in the range described above, the adhesive force to various members can be reduced by the spacer effect. In addition, the toner can suppress the decrease of its fluidity, which originates in the silica aggregated particle. Because of this, even when the toner has been used for a long period of time in a low-temperature and low-humidity environment, the toner can suppress its deterioration, and can suppress the transfer dropout.

In the present invention, it is preferable that an evaluation index for degree of dispersion of the silica aggregated particle on the surface of the toner particle is 2.00 or smaller. The evaluation index for degree of dispersion within the above range indicates that the silica aggregated particle is uniformly dispersed on the surface of the toner particle. As a result, the adhesive force to various members can be reduced by the silica aggregated particle on the surface of the toner particle, without increasing the amount of the silica aggregated particle to be added. Because of this, even when the toner has been used for a long period of time in a low-temperature and low-humidity environment, the toner suppresses its deterioration, and the suppression of the transfer dropout can be improved.

The coverage ratio and the evaluation index for degree of dispersion of the silica aggregated particle can be controlled by production conditions in the external addition step, the type of silica aggregated particle, and the amount of the silica aggregated particle to be added.

In addition, in the present invention, when the above abundance of a boron atom in the toner is represented by B (ppm), and the amount of silanol defined by the following Expression (2) is represented by S at the time when the silica aggregated particle is dispersed in a solvent and a titration operation is performed with the use of an aqueous solution of NaOH, it is preferable that B and S satisfy the following Expression (3).

$$\\ \begin{matrix}S = [ ( a - b ) \times c \times NA ] / ( d \times e ) & ( 2 )\end{matrix}$$

$$\\ \begin{matrix}0.03 \leq S / B \leq 20. & ( 3 )\end{matrix}$$

(wherein a is a titration amount (L) of an aqueous solution of NaOH necessary for adjusting a mixed liquid of 25.0 g of ethanol and 75.0 g of an aqueous solution of 20% by mass of NaCl in which the silica aggregated particle is dispersed, to pH 9,
b is a titration amount (L) of the aqueous solution of NaOH necessary for adjusting a mixed liquid of 25.0 g of ethanol and 75.0 g of the aqueous solution of 20% by mass of NaCl, to pH 9,
c is a concentration (N) of the aqueous solution of NaOH used for the titration, NA is Avogadro's number,
d is a mass (g) of the silica aggregated particle, and
e is a BET specific surface area (nm²/g) of the silica aggregated particle).

S/B defined by the above Expression (3) is more preferably from 0.03 to 15.0, and is further preferably from 0.05 to 3.00.

When the S/B defined by the above Expression (3) is in the above range, the effect of the electrostatic interaction can be enhanced which acts between the silica aggregated particle and the toner particle. Thereby, when the silica aggregated particle has been added, the adhesiveness of the silica aggregated particle to the surface of the toner particle can be enhanced. Because of this, even when the toner has been used in a low-temperature and low-humidity environment for a long period of time, the transfer dropout can be suppressed which is caused by the detachment of the silica aggregated particle.

The toner of the present invention is configured so that it is also preferable to use a titanium oxide particle that satisfies the following (i) and (ii), in addition to the silica aggregated particle:
(i) a major axis is from 300 to 3000 nm, and
(ii) an aspect ratio is 5.0 or more.

A titanium oxide particle satisfying the above (i) and (ii) is classified to have a large particle size and low resistance as an external additive, and shows that the structure is a needle-shaped. A use of the titanium oxide particle can suppress an excessive electrostatic charging in a low-temperature and low-humidity environment, and also can suppress the embedding of the silica aggregated particle, due to the adherence to the surface of the toner particle and the spacer effect. Because of this, the change in fluidity at the time of long-term use becomes small, and accordingly, even when the toner has been used for a long period of time in a low-temperature and low-humidity environment, the toner can suppress its deterioration and improve the suppression of the transfer dropout.

The content of the above titanium oxide particle in the toner is preferably from 0.1 to 10 parts by mass with respect to 100 parts by mass of the toner. The lower limit is more preferably 0.5 parts by mass or more. In addition, the upper limit is more preferably 8.0 parts by mass or less.

For information, the above titanium oxide particle is not particularly limited as long as the titanium oxide particle satisfies the above requirements (i) and (ii). For example, a rutile-type titanium oxide particle is one of preferable embodiments.

It is also preferable to use a titanium oxide particle B which does not correspond to the above titanium oxide particle in combination, because a change in the charge amount tends to be easily suppressed. In the titanium oxide particle B, a particle size on the toner surface is from 20 to 250 nm.

In the present invention, it is preferable that an average circularity of the toner is from 0.960 to 0.990. When the average circularity of the toner is 0.960 or more, a shape of the toner becomes a spherical shape or a shape close thereto, and the toner is excellent in the fluidity. Because of this, even when the toner has been used for a long period of time in a low-temperature and low-humidity environment, the transfer dropout due to a decrease in the fluidity can be suppressed.

The toner of the present invention has a shell layer on the surface of the toner particle; and it is preferable that the shell layer existing on the surface of the toner particle contains a polyester resin, the shell layer does not contain a crystalline material in a cross section of the toner that is observed with a transmission electron microscope, and when T (nm) represents a thickness of the shell layer, the following Expression (4) is satisfied.

$$\\ \begin{matrix}300 \leq T \leq 700 & ( 4 )\end{matrix}$$

The toner particle having the shell layer made from a polyester resin has polarity also in a region of the surface of the toner particle other than the BO structure, and accordingly, can enhance an effect of the electrostatic interaction with the silanol of the silica aggregated particle. In addition, the shell layer does not contain the crystalline material and satisfies the above Expression (4); and thereby, even when the toner has been used in a low-temperature and low-humidity environment for a long period of time, the toner can suppress the transfer dropout.

It is preferable that the toner of the present invention contains dodecylbenzenesulfonic acid or a dodecylbenzenesulfonate.

The BO bond existing on the toner surface is a functional group having high adsorptivity to a water content, and is considered to retain the water content on the toner surface to some extent even in an environment in which an amount of the water content is small, such as a low-temperature and low-humidity environment. Furthermore, the dodecylbenzenesulfonic acid or the dodecylbenzenesulfonate is water-soluble, accordingly migrates into the water content retained on the toner surface, and becomes a state of being movable in the toner surface containing the water content.

Then, the sulfonic acid moiety in a dodecylbenzenesulfonic acid structure and the silanol group on the surface of the silica aggregated particle electrostatically adsorb to each other, which has the other polarity of the present invention. As a result, it is considered that excessive charges of silica tend to become easily leaked into a surrounding water content or the like through the dodecylbenzenesulfonic acid or the dodecylbenzenesulfonate, and that the toner can suppress the excessive electrostatic charging.

The measurement of the dodecylbenzenesulfonic acid will be described in detail later, but it can be known by ESI-MS measurement whether or not the dodecylbenzenesulfonic acid exists in the vicinity of the surface, and furthermore, the content thereof in the toner can be known.

### Each Constituent Material of Toner

### Silica Aggregated Particle

The silica aggregated particle used in the toner of the present invention will be described below.

### Original Substance

An original substance of the silica aggregated particle used in the present invention includes both of dry silica that is produced by vapor phase oxidation of a silicon halogen compound and called fumed silica, and wet silica that is produced from water glass or the like. In the present invention, the dry silica is more preferable which has less silanol groups on the surface and in the inside, and does not contain a production residue.

The dry method is, for example, a method of utilizing a thermal decomposition oxidation reaction of silicon tetrachloride gas in an oxyhydrogen flame, and the basic reaction formula is as follows. Specifically, an original substance of the silica aggregated particle can be obtained by operations of: introducing a gas of a silicon compound of a raw material into a mixing chamber of a combustion burner together with an inert gas; mixing the gases with hydrogen and air to form a mixed gas having a predetermined ratio; and combusting this mixed gas at a temperature of 1000 to 3000° C. in a reaction chamber to produce silica; and after cooling, collecting the produced silica with a filter.

$$\\ {SiCl}_{4} + 2 {H}_{2} + {O}_{2} \to {SiO}_{2} + 4 HCl$$

In the above production method, the original substance of the silica aggregated particle having a desired aggregated structure can be obtained by operations of: keeping a temperature in the reaction chamber to the melting point of silica or higher; allowing the silicon compound of the raw material to stay in the reaction chamber; and thereby growing the silica aggregated particle. In particular, it is preferable to firstly produce a primary particle of the silica aggregated particle in a flame hydrolysis step, and to aggregate the primary particle of the silica aggregated particle in an aggregation step. In the flame hydrolysis step, the primary particle size of the silica aggregated particle can be controlled by a silica concentration, and in the aggregation step, the aggregation structure of the silica aggregated particle can be controlled by a staying time period, which are preferable.

### Surface Treatment Agent

The silica aggregated particle of the present invention preferably contains an original substance of silica which has been treated with hexamethyldisilazane or polydimethylsiloxane represented by a Structural Formula (A) as a surface treatment agent.

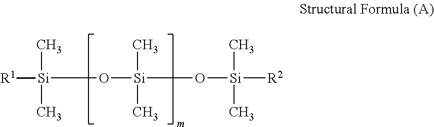

(wherein R¹ is a carbinol group, a hydroxy group, an epoxy group, a carboxy group, an alkyl group or a hydrogen atom, and R² is a carbinol group, a hydroxy group, an epoxy group, a carboxy group or a hydrogen atom; and m is an average number of repeating units, and m is from 30 to 200.)

It is preferable to treat the original substance of the silica aggregated particle with the above surface treatment agent, because the surface of the original substance of the silica aggregated particle can be hydrophobized while allowing the silanol to remain in the silica aggregated particle. In the silica aggregated particle which has been surface-treated with hexamethyldisilazane, the silanol remains under the bulk of a trimethylsilyl group, because the trimethylsilyl group is a bulky substituent. Similarly, in the polydimethylsiloxane represented by the Structural Formula (A), the terminal functional group reacts with the silanol of the original substance of silica and bonds to the original substance of silica, and accordingly, the silanol remains under the umbrella of the substituent group. As a result, the effect of the electrostatic interaction is improved which acts between the silanol of the silica aggregated particle and the BO structure existing on the surface of the toner particle, and even when the toner has been used for a long period of time in a low-temperature and low-humidity environment, the toner can suppress the transfer dropout which is caused by the detachment of the silica aggregated particle.

It is preferable that the molecular weight of the polydimethylsiloxane represented by the Structural Formula (A) to be used in the present invention is, for example, from 250 to 50000, in terms of a number average molecular weight, particularly from 250 to 10000, and especially from 250 to 5000. When the molecular weight of the polydimethylsiloxane is too large, the volatility is low, and the polydimethylsiloxane cannot be efficiently evaporated, removed, and reacted with the original substance of silica, by the surface treatment which will be described later. On the other hand, when the molecular weight of polydimethylsiloxane is too small, it becomes difficult to impart high hydrophobicity.

It is preferable to dilute the polydimethylsiloxane represented by the Structural Formula (A) with hexane, toluene, an alcohol (an aliphatic alcohol having from 1 to 8 carbon atoms such as methanol, ethanol and propanol), acetone or the like, or water or the like in some cases, for example, to about 5 to 50% by mass, and to use the liquid for the surface treatment, because uniform treatment is possible.

The amounts of the hexamethyldisilazane and the polydimethylsiloxane to be used for the surface treatment of the silica aggregated particle vary depending on the type (specific surface area and the like) of an original substance of the silica aggregated particle, the type (molecular weight and the like) of the surface treatment agent, and the like; but in general, are preferably from 0.1 parts by mass to 10 parts by mass, are particularly preferably from 0.1 to 5 parts by mass, and are especially preferably from 0.1 to 3 parts by mass, with respect to 100 parts by mass of the silica aggregated particle. When the amount of the surface treatment agent is too little, a silica fine particle having high hydrophobicity cannot be obtained. On the other hand, when an excessive amount of the surface treatment agent is used, the hydrophobicity of the silica fine particle can be enhanced, but the silica fine particle tends to easily become aggregated, which is not preferable.

### Surface Treatment Method

It is preferable to perform the surface treatment in an inert gas atmosphere such as a nitrogen atmosphere, in order to prevent hydrolysis and oxidation. Specifically, a method is employed which includes: charging the original substance of the silica aggregated particle into a container equipped with a stirring apparatus such as a Henschel mixer; stirring the original substance under nitrogen purge, spraying the surface treatment agent; mixing the agent with the original substance of the silica aggregated particle; and heating the mixture to cause the mixture to react. The spray may be carried out prior to heating or while heating to a treatment temperature or lower.

### Treatment Conditions

The surface treatment is a fixing treatment by causing the surface treatment agent to react with the surface of the original substance of the silica aggregated particle, by imparting the previously described predetermined amount of the surface treatment agent to the original substance of the silica aggregated particle, and heating the agent under stirring. Here, it is also acceptable to dilute the polydimethylsiloxane represented by the Structural Formula (A) by any of the previously described various solvents, and impart the liquid to the original substance of the silica aggregated particle.

A heating temperature in the surface treatment varies depending on the reactivity of the used surface treatment agent or the like, but is set at 150 to 280° C., and is particularly preferable to be 200 to 280° C.; and the treatment time period varies depending on the heating temperature and the reactivity of the surface treatment agent used, but is set at 5 to 120 minutes, is particularly preferable to be 5 to 60 minutes, and is especially preferable to be 5 to 40 minutes.

When the treatment temperature of the surface treatment is too low or the treatment time period is too short, the surface treatment agent cannot sufficiently react with the original substance of silica, and the hydrophobicity of the silica aggregated particle decreases. On the other hand, even when the treatment temperature is too high, there is a possibility that the hydrophobicity decreases. In addition, when the treatment time period is too long, the production efficiency is lowered, which is not preferred.

On the surface of the toner, an inorganic fine particle other than the above described silica aggregated particle may exist. Examples of the inorganic fine particle can include a silica particle, a titanium oxide particle, an alumina particle and a composite oxide particle thereof.

### Binder Resin

The toner particle of the present invention contains a binder resin. It is preferable that a content of the binder resin is 50% by mass or more of the total amount of the resin components in the toner particle.

The binder resins are not particularly limited, and examples thereof include a styrene acrylic resin, an epoxy resin, a polyester resin, a polyurethane resin, a polyamide resin, a cellulose resin, a polyether resin, and mixed resins and composite resins of these resins. The styrene acrylic resin and the polyester resin are preferable from the viewpoint of low-temperature fixability and durability stability.

Examples of the styrene acrylic resin include: homopolymers formed from the following polymerizable monomers; copolymers obtained by combining two or more types of these polymerizable monomers; and further mixtures thereof.
Styrene-based monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene;
(meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth) acrylate, diethyl phosphate ethyl (meth) acrylate, dibutyl phosphate ethyl (meth) acrylate, 2-benzoyloxyethyl (meth)acrylate, (meth)acrylonitrile, 2-hydroxyethyl (meth)acrylate, (meth)acrylic acid, and maleic acid;
vinyl ether-based monomers such as vinyl methyl ether and vinyl isobutyl ether; vinyl ketone-based monomers such as vinyl methyl ketone, vinyl ethyl ketone, and vinyl isopropenyl ketone; and
polyolefins such as ethylene, propylene and butadiene.

The styrene acrylic resin can contain a polyfunctional polymerizable monomer as needed. Examples of the polyfunctional polymerizable monomer include: diethylene glycol di(meth)acrylate, triethylene glycol di(meth)acrylate, tetraethylene glycol di(meth)acrylate, polyethylene glycol di(meth)acrylate, 1,6-hexanediol di(meth)acrylate, neopentyl glycol di(meth)acrylate, tripropylene glycol di(meth)acrylate, polypropylene glycol di(meth)acrylate, 2,2′-bis(4-((meth)acryloxydiethoxy)phenyl) propane, trimethylolpropane tri(meth)acrylate, tetramethylolmethane tetra(meth)acrylate, divinylbenzene, divinylnaphthalene and divinyl ether.

In addition, in order to control a degree of polymerization, a known chain transfer agent and a known polymerization inhibitor can also be further added. Examples of the polymerization initiator for obtaining the styrene acrylic resin include organic peroxide-based initiators and azo-based polymerization initiators.

Examples of the organic peroxide-based initiator include: benzoyl peroxide, lauroyl peroxide, di-α-cumyl peroxide, 2,5-dimethyl-2,5-bis(benzoylperoxy) hexane, bis(4-t-butylcyclohexyl) peroxydicarbonate, 1,1-bis(t-butylperoxy) cyclododecane, t-butyl peroxymaleic acid, bis(t-butylperoxy) isophthalate, methyl ethyl ketone peroxide, tert-butyl peroxy-2-ethylhexanoate, diisopropyl peroxycarbonate, cumene hydroperoxide, 2,4-dichlorobenzoyl peroxide and tert-butyl-peroxypivalate.

Examples of the azo-based polymerization initiator include: 2,2′-azobis-(2,4-dimethylvaleronitrile), 2,2′-azobisisobutyronitrile, 1, l′-azobis(cyclohexane-1-carbonitrile), 2,2′-azobis-4-methoxy-2,4-dimethylvaleronitrile, azobismethylbutyronitrile, and 2,2′-azobis-(methyl isobutyrate).

In addition, as the polymerization initiator, a redox-based initiator can also be used in which an oxidizing substance and a reducing substance are combined.

The oxidizing substance includes: hydrogen peroxide; an inorganic peroxide of a persulfate (a sodium salt, a potassium salt and an ammonium salt); and an oxidizing metal salt of a tetravalent cerium salt.

Examples of the reducing substance include; a reducing metal salt (a divalent iron salt, a monovalent copper salt and a trivalent chromium salt); ammonia; a lower amine (an amine having from about 1 to 6 carbon atoms, such as methylamine and ethylamine); an amino compound such as hydroxylamine; a reducing sulfur compound such as sodium thiosulfate, sodium hydrosulfite, sodium hydrogen sulfite, sodium sulfite and sodium formaldehyde sulfoxylate; a lower alcohol (having from 1 to 6 carbon atoms); ascorbic acid or a salt thereof; and a lower aldehyde (having from 1 to 6 carbon atoms).

The polymerization initiators are selected with reference to a 10-hour half-life temperature, and are used singly or in mixture. The amount of the polymerization initiator to be added varies depending on a desired degree of polymerization, but is generally from 0.5 to 20.0 parts by mass with respect to 100.0 parts by mass of the polymerizable monomer.

In the toner of the present invention, a constitution is preferable in which the binder resin is a styrene acrylic resin and the shell layer includes a polyester resin, because the toner has a good balance between electrostatic chargeability and durability and is excellent in the suppression of the transfer dropout.

### Polyester Resin

A polyester resin to be used in the toner particle of the present invention will be described below. For information, also for the polyester resin contained in the shell layer existing on the surface of the toner particle of the present invention, the polyester resin described below can be used. The polyester resin that can be used in the present invention is not particularly limited, but is preferably an amorphous polyester resin; and examples thereof include the following.

The polyester resin is obtained by selection and combination of suitable ones from polyvalent carboxylic acid, polyol, hydroxycarboxylic acid and the like, and synthesis by a known method such as an ester exchange method or a polycondensation method. Preferably, the polyester resin includes a polycondensate of a dicarboxylic acid and a diol.

The polyvalent carboxylic acid is a compound containing two or more carboxy groups in one molecule. Among these compounds, dicarboxylic acid is a compound containing two carboxy groups in one molecule and is preferably used.

The examples include: oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid and cyclohexanedicarboxylic acid.

In addition, examples of the polyvalent carboxylic acid other than the above dicarboxylic acid include: trimellitic acid, trimesic acid, pyromellitic acid, naphthalene tricarboxylic acid, naphthalene tetracarboxylic acid, pyrene tricarboxylic acid, pyrene tetracarboxylic acid, itaconic acid, glutaconic acid, n-dodecyl succinic acid, n-dodecenyl succinic acid, isododecyl succinic acid, isododecenyl succinic acid, n-octyl succinic acid and n-octenyl succinic acid. These may be used singly, or in combinations of two or more thereof.

The polyol is a compound having two or more hydroxyl groups in one molecule. Among these polyols, a diol is a compound containing two hydroxyl groups in one molecule, and is preferably used.

Specific examples include: ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosandecanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol A, bisphenol A, bisphenol F, bisphenol S, and alkylene oxide (ethylene oxide, propylene oxide, butylene oxide and the like) adducts of the above bisphenols.

Among the compounds, alkylene glycols having from 2 to 12 carbon atoms and alkylene oxide adducts of bisphenols are preferable; and alkylene oxide adducts of bisphenols, and combination use of the adducts with alkyleneglycols having from 2 to 12 carbon atoms are particularly preferable. The alkylene oxide adduct of bisphenol A includes a compound represented by the following Formula (I).

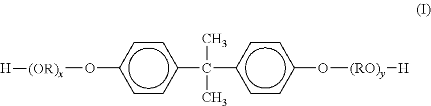

(wherein R is each independently an ethylene group or a propylene group, x and y are each an integer of 0 or more, and an average value of x+y is from 0 to 10.)

It is preferable that the alkylene oxide adduct of bisphenol A is a propylene oxide adduct and/or an ethylene oxide adduct of bisphenol A. More preferably, the alkylene oxide adduct is the propylene oxide adduct. In addition, it is preferable that an average value of x+y is from 1 to 5 or smaller.

Examples of a trivalent or higher alcohol include: glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and alkylene oxide adducts of the above trivalent or higher polyphenols. These may be used singly, or in combinations of two or more thereof.

Regarding physical properties of the polyester resin to be used in the present invention, a weight-average molecular weight is preferably from 9000 to 15000 and an acid number is preferably from 4.0 to 10.0 mgKOH/g.

### Wax

A well-known wax can be used as the toner of the present invention.

Specific examples thereof include: petroleum-based waxes represented by paraffin wax, microcrystalline wax and petrolatum, and derivatives thereof; montan wax and derivatives thereof; hydrocarbon wax produced by a Fischer-Tropsch method and derivatives thereof; polyolefin waxes represented by polyethylene, and derivatives thereof; natural waxes represented by carnauba wax and candelilla wax, and derivatives thereof. The derivatives include oxides, block copolymers with a vinyl monomer, and graft modified products.

The specific examples also include: alcohols such as higher aliphatic alcohols; fatty acids such as stearic acid and palmitic acid, or acid amides, esters and ketones thereof; hydrogenated castor oil and derivatives thereof; vegetable waxes; and animal waxes. These can be used singly or in combinations.

Among these waxes and the like, in a case where polyolefin, hydrocarbon wax produced by a Fischer-Tropsch method or petroleum-based wax is used, the developability and transferability tend to be improved, which is preferable. Note that an antioxidant may be added to these waxes in such a range as not to give influence on the effect of the toner. In addition, suitable examples, from the viewpoint of phase separation properties with respect to the binder resin or a crystallization temperature, include higher fatty acid esters such as behenyl behenate and dibehenyl sebacate.

In addition, it is preferable that a content of the release agent is from 1.0 to 30.0 parts by mass, with respect to 100.0 parts by mass of the binder resin.

A melting point of the release agent is preferably from 30° C. to 120° C., and is more preferably from 60° C. to 100° C. Due to use of such a release agent as to exhibit the thermal characteristics as described above, the release effect is efficiently exhibited, and a wider fixing region is secured.

### Plasticizer

The toner particle may contain a crystalline plasticizer in order to improve a sharp meltability. The plasticizer is not particularly limited, and the following known plasticizers can be used which are used for toners.

Specific examples include: esters of a monovalent alcohol and an aliphatic carboxylic acid, such as behenyl behenate, stearyl stearate and palmityl palmitate, or esters of a monovalent carboxylic acid and an aliphatic alcohol; esters of a divalent alcohol and an aliphatic carboxylic acid, such as ethylene glycol distearate, dibehenyl sebacate and hexanediol dibehenate, or esters of a divalent carboxylic acid and an aliphatic alcohol; esters of a trivalent alcohol and an aliphatic carboxylic acid, such as glycerol tribehenate, or esters of a trivalent carboxylic acid and an aliphatic alcohol; esters of a tetravalent alcohol and an aliphatic carboxylic acid, such as pentaerythritol tetrastearate and pentaerythritol tetrapalmitate, or esters of a tetravalent carboxylic acid and an aliphatic alcohol; esters of a hexavalent alcohol and an aliphatic carboxylic acid, such as dipentaerythritol hexastearate and dipentaerythritol hexapalmitate, or esters of a hexavalent carboxylic acid and an aliphatic alcohol; esters of a polyvalent alcohol and an aliphatic carboxylic acid, such as polyglycerol behenate, or esters of a polyvalent carboxylic acid and an aliphatic alcohol; and natural ester waxes such as carnauba wax and rice wax. These can be used singly or in combinations.

### Coloring Agent

The toner particle may contain a coloring agent. As the coloring agent, a known pigment or dye can be used. As the coloring agent, a pigment is preferable from the viewpoint of being excellent in weather resistance.

Examples of a cyan coloring agent include: copper phthalocyanine compounds and derivatives thereof; anthraquinone compounds; and basic dye lake compounds. Specific examples thereof include the following coloring agents: C. I. Pigment Blue 1, 7, 15, 15:1, 15:2, 15:3, 15:4, 60, 62 and 66.

Examples of a magenta coloring agent include condensed azo compounds, diketopyrrolopyrrole compounds, anthraquinone compounds, quinacridone compounds, basic dye lake compounds, naphthol compounds, benzimidazolone compounds, thioindigo compounds and perylene compounds. Specific examples thereof include the following coloring agents: C. I. Pigment Red 2, 3, 5, 6, 7, 23, 48:2, 48:3, 48:4, 57:1, 81:1, 122, 144, 146, 150, 166, 169, 177, 184, 185, 202, 206, 220, 221 and 254; and C. I. Pigment Violet 19.

Examples of a yellow coloring agent include: condensed azo compounds, isoindolinone compounds, anthraquinone compounds, azo metal complexes, methine compounds and allylamide compounds. Specific examples thereof include the following coloring agents: C. I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191 and 194.

Examples of a black coloring agent include: a coloring agent which is toned to black with the above yellow coloring agent, the magenta coloring agent and the cyan coloring agent; carbon black; and magnetic substances.

These coloring agents can be used singly or as a mixture, and further can be used in a state of a solid solution. It is preferable to use the coloring agent in an amount of from 1.0 to 20.0 parts by mass, with respect to 100.0 parts by mass of the binder resin. For information, in a case where a production method that uses a magnetic substance in an aqueous medium is applied to the toner particle, which will be described later, the magnetic substance can also be subjected to hydrophobic treatment for the purpose of causing the resin to stably contain the magnetic substance therein.

### Charge Control Agent and Charge Control Resin

The toner particle may contain a charge control agent or a charge control resin. As the charge control agent, known charge control agents can be used, and particularly, the charge control agent is preferable which has a high triboelectric charging speed and can stably maintain a constant triboelectric charge amount. Furthermore, when the toner particle is produced according to a suspension polymerization method, a charge control agent is particularly preferable which has low polymerization inhibiting property and does not substantially contain a substance soluble in the aqueous medium.

Examples of compounds that control the toner to negative chargeability include: monoazo metal compounds: acetylacetone metal compounds; metal compounds of aromatic oxycarboxylic acid, aromatic dicarboxylic acid, oxycarboxylic acid and dicarboxylic acid; aromatic oxycarboxylic acid, aromatic mono- and polycarboxylic acids, and metal salts, anhydrides and esters thereof; phenol derivatives such as bisphenol; urea derivatives; metal-containing salicylic acid-based compounds; metal-containing naphthoic acid-based compounds; boron compounds; quaternary ammonium salts; calixarenes; and charge control resins.

Examples of the charge control resin include polymers or copolymers having a sulfonic acid group, a sulfonate group or a sulfonic acid ester group. It is particularly preferable for the polymer having a sulfonic acid group, a sulfonate group or a sulfonic acid ester group to contain a sulfonic acid group-containing acrylamide-based monomer or a sulfonic acid group-containing methacrylamide-based monomer in an amount of 2% by mass or more by a copolymerization ratio, and is more preferable to contain any of the monomers in an amount of 5% by mass or more.

It is preferable for the charge control resin that a glass transition temperature (Tg) is from 35° C. to 90° C., a peak molecular weight (Mp) is from 10000 to 30000, and a weight-average molecular weight (Mw) is from 25000 to 50000. When this charge control resin is used, the charge control resin can impart favorable triboelectric charging characteristics to the toner particle without affecting the required thermal characteristics. Furthermore, when the charge control resin contains the sulfonic acid group, for example, the dispersibility of the charge control resin itself in the polymerizable monomer composition and the dispersibility of the coloring agent and the like are improved, and the coloring power, transparency and triboelectric charging characteristics can be further improved.

These charge control agents or charge control resins may be added singly or in combinations of two or more thereof. The amount of the charge control agent or the charge control resin to be added is preferably from 0.01 to 20.0 parts by mass, and is more preferably from 0.5 to 10.0 parts by mass, with respect to 100.0 parts by mass of the binder resin.

### Method for Producing Toner Particle

A method for producing the toner is not particularly limited, and a known method can be used such as a pulverization method, a suspension polymerization method, a dissolution suspension method, an emulsion aggregation method or a dispersion polymerization method. In such an arbitrary method for producing the toner particle, it is preferable to obtain the toner particle by addition of a boric acid source when raw materials are mixed. Here, it is preferable that the toner is produced by a method shown in the following. In other words, it is preferable that the toner is produced by an emulsion aggregation method.

Preferably, the method for producing the toner includes the following steps (1) to (3):
(1) a dispersion step of adjusting a dispersion of binder resin fine particles containing a binder resin;
(2) an aggregation step of forming an aggregated body by aggregation of the binder resin fine particles contained in the dispersion of the binder resin fine particles; and
(3) a fusion step of heating and fusing the aggregated body,

Wherein
in the step (2) or (3), a boric acid source is added to the dispersion.

A method for producing the toner particle according to the emulsion aggregation method will be described in detail below, with reference to Examples.

### Dispersion Preparation Step

A binder-resin particle dispersion is prepared, for example, in the following way. When the binder resin is a homopolymer or copolymer (vinyl-based resin) of a vinyl-based monomer, a dispersion in which particles of the vinyl-based resin are dispersed in an ionic surface-active agent is prepared by subjecting the vinyl-based monomer to emulsion polymerization, seed polymerization or the like in the ionic surface-active agent.

When the binder resin is a resin other than the vinyl-based resin, such as a polyester resin, the resin is mixed with an aqueous medium in which an ionic surface-active agent or a polymer electrolyte is dissolved.

After that, this solution is heated to a temperature of the melting point or softening point of the resin or higher to dissolve the resin therein, and the particles of the binder resin are dispersed in the ionic surface-active agent with the use of a dispersing machine having a strong shearing force such as a homogenizer; and thus, the dispersion is prepared.

The units for dispersion is not particularly limited, and examples thereof include known dispersing apparatuses such as a rotary shearing homogenizer, a ball mill, and a sand mill and a dyno mill which have media; and in addition, a phase inversion emulsification method may be used as a method for preparing the dispersion. The phase inversion emulsification method is a method of dissolving a binder resin in an organic solvent, adding a neutralizing agent or a dispersion stabilizer as needed, adding dropwise an aqueous solvent under stirring to obtain an emulsified particle, and then removing the organic solvent in the resin dispersion to obtain an emulsified liquid. At this time, the order of charging of the neutralizing agent and the dispersion stabilizer may be changed.

In the emulsion aggregation method, a coloring-agent particle dispersion can be used as needed. The coloring-agent particle dispersion is obtained by dispersing at least coloring-agent particles are dispersed in a dispersing agent.

In the emulsion aggregation method, a plasticizing-agent particle dispersion can be used as needed. The plasticizing-agent particle dispersion is obtained by dispersing at least plasticizing agent particles in a dispersing agent.

### Aggregation Step

The aggregation step for forming the aggregated particle is a step for forming the aggregated particle containing a binder resin particle, a wax particle, and a coloring-agent particle and a plasticizing agent particle which are added as needed, in an aqueous medium containing the binder resin particle, the wax particle, and the coloring-agent particle and the plasticizing agent particle which are contained as needed.

### Fusion Step

The fusion step is a step of heating and fusion bonding the obtained aggregated particle. Before the fusion step, a pH adjusting agent, a polar surface-active agent, a nonpolar surface-active agent or the like can be appropriately charged, in order to prevent fusion bonding between toner particles.

The heating temperature may be from a glass transition temperature of the resin contained in the aggregated particle (in the case where types of the resin are two or more, the glass transition temperature of the resin having the highest glass transition temperature) to a decomposition temperature of the resin. Accordingly, the heating temperature varies depending on the type of the resin of the binder resin particle and cannot be unconditionally specified, but is generally from the glass transition temperature of the resin contained in the aggregated particle to 140° C. For information, the heating can be performed with the use of a heating apparatus or instrument of which the name is known.

As a time period for fusion bonding, a short time is sufficient when the heating temperature is high, and a long time is necessary when the heating temperature is low. In other words, the time period for the fusion cannot be unconditionally specified because of depending on the heating temperature, but is generally from 30 minutes to 10 hours.

The toner particle is obtained by performing the above dispersion preparation step, aggregation step and fusion step. The obtained toner particle is filtered, washed and dried by a known method as a toner particle as it is, and thus the toner particle can be obtained.

It is preferable in the method for producing the toner particle to include a shell forming step of: obtaining a toner particle (core particle) by the above described arbitrary production method; forming a shell by further adding a resin fine particle containing a resin for the shell to an aqueous medium in which the core particles are dispersed; and attaching the resultant liquid to the core particle. It is preferable in the method for producing a toner by the emulsion aggregation method to include a shell forming step of: forming an aggregated particle (core particle) in the aggregation step; and then further adding a resin fine particle containing a resin for the shell; and attaching the resin fine particle to the core particle to form the shell thereon. In other words, it is preferable that the toner particle has the core particle containing the binder resin and the shell on the surface of the core particle. The resin to be used for the shell may be the same resin as the binder resin, or may be another resin. The amount of the resin for the shell to be added is preferably from 1 to 10 parts by mass, and is more preferably from 2 to 7 parts by mass, with respect to 100 parts by mass of the binder resin contained in the core particle.

In this case, it is preferable that the method for producing the toner includes the following steps:
(1) a dispersion step of preparing a dispersion of the binder resin fine particle containing the binder resin;
(2-1) an aggregation step of forming an aggregated body by aggregation of the binder resin fine particles contained in the dispersion of the binder resin fine particles;
(2-2) a shell forming step of further adding a resin fine particle containing the resin for the shell to the dispersion containing the aggregated body, and attaching the resin fine particle to the aggregated body to form an aggregated body having the shell thereon; and
(3) a fusion step of heating and fusing the aggregated body on which the shell is formed.

In addition, in order to facilitate boric acid to be contained in the vicinity of the surface of the toner particle, it is preferable to add a boric acid source to the dispersion containing the aggregated body together with the resin fine particle containing the resin for the shell in the step (2-2).

The boric acid source may be boric acid, or a compound which can be converted into boric acid by pH control or the like while the toner is produced. Example thereof includes at least one selected from the group consisting of boric acid, borax, organic boric acid, a borate and a borate ester. For example, it is acceptable to add a boric acid source and control the boric acid so as to be contained in the aggregated body. Preferably, the pH is controlled to be acidic in the aggregation step (2-1), and the shell forming step is performed.

Boric acid may exist in the aggregated body in an unsubstituted state. The boric acid source is preferably at least one selected from the group consisting of boric acid and borax. When the toner is produced in an aqueous medium, it is preferable to add the boric acid source in a form of a borate, from the viewpoint of reactivity and production stability. Specifically, the boric acid source preferably includes at least one selected from the group consisting of sodium tetraborate, borax, ammonium borate and the like, and is further preferably borax.

Borax is indicated by decahydrate of sodium tetraborate (Na₂B₄O₇), and changes into boric acid in an acidic aqueous solution; and accordingly, when the boric acid source is used in an acidic environment in an aqueous medium, borax is preferably used. As an addition method, borax may be added in any form of a dry powder or an aqueous solution in which the borax is dissolved in an aqueous medium, but in order to cause uniform aggregation, it is preferable to add the borax in the form of an aqueous solution. The concentration of the aqueous solution may be appropriately changed according to the concentration to be included in the toner, and is, for example, 1 to 20% by mass. In order to convert the borax into boric acid, it is preferable to adjust a pH to an acidic condition, before addition, at the time of addition or after the addition. It is acceptable to control the pH, for example, to 1.5 to 5.0, and is preferable to control to 2.0 to 4.0. Preferably, the pH is controlled prior to the aggregation step which forms the aggregated body.

In other words, it is preferable to control the pH to an acidic condition in the mixing step of mixing the dispersion of the binder resin fine particle and, if necessary, other dispersions such as a release agent particle dispersion, before the aggregation step.

### Method for Measuring Each Physical Property

Next, methods for measuring each physical property according to the present invention will be described.

### Method for Measuring Fragment Peaks Derived from Boron Atom and BO Structure

The fragment peaks derived from the boron atom and the BO structure in the toner were detected with the use of TOF-SIMS.

TRIFT-IV manufactured by ULVAC-PHI, Inc. is used for the measurement of the fragment ions on the toner surface, in which TOF-SIMS is used. Analysis conditions are as follows.
Sample preparation: to attach silica fine particle to an indium sheet.
Primary ion: Au ion
Acceleration voltage: 30 kV
Charge neutralization mode: On
Measurement mode: Positive
Raster: 200 μm
Measurement time period: 60 s

It is confirmed whether a fragment ion derived from a boron atom is observed, from an obtained mass profile of secondary ion mass/secondary ion charge number (m/z). For information, in the present invention, the presence or absence of the BO bond has been determined according to the presence or absence of the mass profile of the BO₂, in consideration of a balance with peak intensity.

### Method for Measuring Primary Particle Size Based on Number, Maximum Feret's Diameter and Aspect Ratio of Silica Aggregated Particle

The primary particle size based on number, the maximum Feret's diameter and the aspect ratio of the silica aggregated particle is calculated from an image of a silica fine particle on the toner surface, which is captured by a Hitachi ultra-high resolution field emission scanning electron microscope S-4800 (Hitachi High-Technologies Corporation). The image photographing conditions in S-4800 are as follows.

### (1) Sample Production

An electroconductive paste is applied thinly onto a sample stage (aluminum sample stage of 15 mm×6 mm), and a toner is sprayed on the paste. Furthermore, air is blown thereto to remove excess toner from the sample stage and the toner is sufficiently dried. The sample stage is set on a sample holder, and the height of the sample stage is adjusted to 36 mm by a sample height gauge.

### (2) Setting of S-4800 Observation Conditions

The primary particle size based on number, the maximum Feret's diameter and the aspect ratio of the silica aggregated particle are calculated with the use of an image which has been obtained by observation of a reflected electron image of S-4800. The reflected electron image is less in charge-up of the silica fine particles than the secondary electronic image, and accordingly, the particle size of the silica fine particle can be measured with high accuracy.

Liquid nitrogen is injected into an anti-contamination trap which is attached to the housing of the S-4800, until the liquid nitrogen overflows, and the anti-contamination trap is left for 30 minutes. The “PC-SEM” in S-4800 is activated, and flushing (cleaning of the FE chip of the electron source) is performed. The acceleration voltage display portion of a control panel on the screen is clicked, a [Flushing] button is pressed, and a flushing execution dialog is opened. The flushing intensity is confirmed to be 2, and the flushing is executed. It is confirmed that the emission current due to the flushing is 20 to 40 μA. The sample holder is inserted into a sample chamber of the housing of S-4800. An [origin point] on the control panel is pressed to move the sample holder to the observation position.

An acceleration voltage display portion is clicked to open an HV setting dialog, and an acceleration voltage is set to [0.8 kV] and an emission current is set to [20 μA]. In a tab of [Basic] of an operation panel, a signal selection is set to [SE]; and [Upper (U)] and [+BSE] of an SE detector are selected, and [L.A. 100] is selected in a selection box on the right of [+BSE] to set a mode for observation with a reflected electron image. Similarly, in a tab of the [Basic] of the operation panel, the probe current is set to [Normal], the focus mode is set to [UHR], and WD is set to [3.0 mm] of an electron optical system condition block. The acceleration voltage is applied by pressing an [ON] button of the acceleration voltage display portion of the control panel.

### (3) Focus Adjustment

A portion inside the magnification display portion on the control panel is dragged to set the magnification to 100000 (100 k) times. A focus knob [COARSE] on the operation panel is rotated, and aperture alignment is adjusted when the focus has been attained to some extent. [Align] on the control panel is clicked to display the alignment dialog, and [Beam] is selected. The STIGMA/ALIGNMENT knobs (X, Y) on the operation panel are rotated to move a displayed beam to the center of the concentric circle. Next, [Aperture] is selected; and the STIGMA/ALIGNMENT knobs (X, Y) are turned one by one, and are adjusted so that the movement of the image stops or becomes minimal. The aperture dialog is closed, and the focus is adjusted by the autofocus. This operation is further repeated twice to adjust the focus.

### (4) Image Storage

Brightness is adjusted in an ABC mode; and the image is photographed into a size of 640×480 pixels, and is then stored. The following analysis is performed with the use of this image file. One photograph is taken for one silica aggregated particle, and images are obtained for at least 300 toner particles.

### (5) Calculation of Primary Particle Size Based on Number of Silica Aggregated Particle

Primary particle sizes of 300 silica aggregated particles are measured to determine the primary particle size based on number. Here, the silica aggregated particle exists as an aggregated lump; and accordingly, the primary particle size based on number of the silica aggregated particle is obtained by operations of: determining the maximum diameters of particles which can be confirmed as the primary particle; and arithmetically averaging the obtained maximum diameters.

### (6) Calculation of Maximum Feret's Diameter and Aspect Ratio of Silica Aggregated Particle

The maximum Feret's diameter and the aspect ratio of the silica aggregated particle are calculated by analysis of the images of 300 silica aggregated particles which have been photographed in the image storage of the above (4), with the use of an image analysis software Image-Pro Plus ver. 5.0 (Nippon Roper Co., Ltd.). The analysis conditions of the image analysis software Image-Pro Plus ver. 5.0 are as follows.

### Software Image-ProPlus5.1J

The binarization conditions are set by selection of “count/size” and “option” in this order from “measurement” of the tool bar. In an object extraction option, an eight-connection is selected, and a smoothing is set to 0. In addition, a selection in advance, a filling of the blank, and an inclusion line are not selected, and “Exclusion of boundary line” is set to “None”. “Shape descriptors” and “Feret's diameter” are selected from the “Measurement” in the toolbar.

As for the calculation of the maximum Feret's diameter and the aspect ratio of the silica aggregated particle, the maximum Feret's diameter and the aspect ratio of the silica aggregated particle are obtained by automatic binarization, by “processing”-binarization.

### Measurement of Silanol Amount of Silica Aggregated Particle Defined by Expression (1)

The silanol amount of the silica aggregated particle defined by the Expression (1) is determined by use of silica aggregated particle which has been separated from the toner, by the following method for separating silica aggregated particle from the toner surface.

### (1) Method for Separating Silica Aggregated Particle from Toner Surface

Sucrose (produced by Kishida Chemical Co., Ltd.) in an amount of 1.6 kg is added to ion-exchanged water in an amount of 1 L, and is dissolved while being heated in a hot water bath; and a sucrose concentrate is prepared. A dispersion is produced by charging of 31 g of the concentrated sucrose, and 6 mL of Contaminon N (aqueous solution of 10% by mass of neutral detergent for cleaning precision measuring instruments, which has a pH of 7, includes nonionic surface-active agent, anionic surface-active agent and organic builder, and is produced by Fuji Film Wako Pure Chemical Corporation), into a centrifuge tube. The toner in an amount of 10 g is added to the dispersion, and a lump of the toner is disaggregated with a spatula or the like.

The centrifuge tube is set in “KM Shaker” (model: V. SX) manufactured by Iwaki Industry Co., Ltd., and is shaken for 20 minutes under a condition of 350 reciprocations per minute. After shaking, the solution is transferred to a glass tube for a swing rotor (50 mL), and is subjected to centrifugal separation in a centrifuge under conditions of 3500 rpm and for 30 minutes.

In the glass tube after the centrifugal separation, the toner particle exists in the uppermost layer, and an inorganic fine particle mixture containing the silica aggregated particle exists on an aqueous solution side of the lower layer. The aqueous solution of the lower layer is separated and then is dried, and an inorganic fine particle mixture is obtained. The above centrifugal separation step is repeated so that the total amount of the obtained inorganic fine particle mixture becomes 10 g or more.

Subsequently, 10 g of the obtained inorganic fine particle mixture is charged into a dispersion containing 100 mL of ion-exchanged water and 6 mL of Contaminon N, and is dispersed therein. The obtained dispersion is transferred to a glass tube for a swing rotor (50 mL), and is subjected to centrifugal separation in a centrifuge under conditions of 3500 rpm and for 30 minutes.

In the glass tube after the centrifugal separation, the silica aggregated particle exists in the uppermost layer, and another inorganic fine particle exists on an aqueous solution side of the lower layer. The aqueous solution of the upper layer is collected, and the centrifugal separation operation is repeated as needed; and after the separation has been sufficiently performed, the dispersion is dried, and the silica aggregated particle is collected.

Next, the silanol amount of the silica aggregated particle which has been collected from the toner is measured under the following measurement conditions.

A sample liquid 1 is prepared by mixture of 25.0 g of ethanol and 75.0 g of an aqueous solution of 20% by mass of sodium chloride. In addition, 2.00 g of the silica fine particle is precisely weighed in a glass bottle, and a sample liquid 2 is prepared by addition of a mixed solvent of 25.0 g of ethanol and 75.0 g of an aqueous solution of 20% by mass of sodium chloride. The sample liquid 2 is stirred for 5 minutes or longer with a magnetic stirrer, and thereby the silica fine particle is dispersed.

Next, for each of the sample liquids 1 and 2, while an aqueous solution of 0.1 mol/L sodium hydroxide is added dropwise at 0.01 mL/min, a pH level of the sample liquid is measured. A titration amount (L) of the aqueous solution of sodium hydroxide is recorded at the time when the pH has reached 9.0. Sn (number/nm²) of an amount of silanol per 1 nm² can be calculated from the following Expression.

S=[(a−b)×c×NA]/(d×e)
a: titration amount (L) of NaOH to sample liquid 2
b: titration amount (L) of NaOH to sample liquid 1
c: concentration (mol/L) of NaOH solution used for titration
NA: Avogadro's number
d: mass of silica fine particle (g)
e: BET specific surface area of silica fine particle (nm²/g)

### Measurement of Abundance of Boron Atoms on Surface of Toner Particle

A content of boron atoms on the surface of the toner particle is measured according to the following measurement method, with the use of an inductively coupled plasma mass spectrometry apparatus (ICP-MS (manufactured by Agilent Technologies Japan Ltd.)).
(a) An aqueous solution of 50% by mass of methanol in an amount of 20 g is added to the toner in an amount of 1 g, the mixture is shaken for 5 minutes at a shaking speed of 150 times per minute with the use of a shaker, and then the toner is taken out. This operation is repeated 10 times.
(b) An aqueous solution of 6.0 mol/L of nitric acid is prepared with the use of 60% nitric acid (produced by Kanto Chemical Co., Inc., Specification Ultrapur) and ultrapure water. A solution sample which contains the toner is produced by adding 5.00 g of 6.0 mol/L of nitric acid to 50.0 mg of the toner, and then mixing and stirring the mixture. The above sample is left to stand for 120 minutes, and boron atoms on the surface of the toner particle are extracted.
(c) The mixture is filtered through a filter paper having a pore size of 1 μm, a toner cake is produced, then, 10.00 g of ultrapure water is added as a washing water to the toner cake, and thus, the toner is separated from the solution sample containing the toner. A solution sample for boron atom measurement is produced by adding ultrapure water to the solution sample of the filtrate so that the total amount becomes 50.00 g.
(d) A content of boron atoms on the toner surface was measured by operations of: using an inductively coupled plasma mass spectrometry apparatus (ICP-MS); preparing a blank solution sample by adding ultrapure water to 5.00 g of an aqueous solution of 6.0 mol/L nitric acid so that the total amount becomes 50.00 g, and a solution sample of which the content of boron atom is known; creating a calibration curve; and quantitatively determining the boron atom contained in the sample for boron atom measurement.

### Method for Measuring Coverage of Silica Aggregated Particle on Surface of Toner Particle

A coverage of the silica aggregated particle is calculated by analysis of the images of the toner surfaces which have been photographed by Hitachi ultra-high-resolution field emission scanning electron microscope S-4800 (manufactured by Hitachi High-Technologies Corporation), with the use of an image analysis software Image-Pro Plus ver. 5.0 (Nippon Roper Co., Ltd.). The image photographing conditions in S-4800 are as follows. In addition, (1) sample preparation and (2) setting of observation conditions of S-4800 are performed in the same methods as the above methods for measuring the primary particle size based on number, the maximum Feret's diameter and the aspect ratio of the silica aggregated particle.

### (3) Focus Adjustment

A focus knob [COARSE] on the operation panel is rotated, and aperture alignment is adjusted when the focus has been attained to some extent. [Align] on the control panel is clicked to display the alignment dialog, and [Beam] is selected. The STIGMA/ALIGNMENT knobs (X, Y) on the operation panel are rotated to move a displayed beam to the center of the concentric circle. Next, [Aperture] is selected; and the STIGMA/ALIGNMENT knobs (X, Y) are turned one by one, and are adjusted so that the movement of the image stops or becomes minimal. The aperture dialog is closed, and the focus is adjusted by the autofocus. After that, the magnification is set to 50,000 (50 k) times, the focus knob, and STIGMA/ALIGNMENT knob are used in the same manner as described above to adjust the focus, and the focus is adjusted again by the autofocus. This operation is further repeated twice to adjust the focus. Here, when the inclination angle of the observation surface is large, the measurement accuracy of the coverage tends to easily become low; and accordingly, the observation surface having as little inclination as possible is selected and analyzed, by selection of the observation surface in which the whole observation surface is simultaneously focused at the time of the focus adjustment.

### (4) Image Storage

Brightness is adjusted in an ABC mode; and the image is photographed with a size of 640×480 pixels, and is stored. The following analysis is performed with the use of this image file. One photograph is taken for one toner, and images are obtained for at least 25 toner or more particles.

### (5) Image Analysis

In the present invention, the coverage is calculated by binarization of the image which has been obtained by the above described method, with the use of the following analysis software. At this time, the above one screen is divided into 12 squares and each is analyzed. The analysis conditions of the image analysis software Image-Pro Plus ver. 5.0 are as follows.

### Software Image-ProPlus5.1J

The binarization conditions are set by selection of “count/size” and “option” in this order from “measurement” of the tool bar. In an object extraction option, an eight-connection is selected, and a smoothing is set to 0. In addition, a selection in advance, a filling of the blank and an inclusion line are not selected, and “Exclusion of boundary line” is set to “None”. A “measurement item” is selected from the “measurement” of the tool bar, and 2 to 107 is input into a sorting range of the area.

The coverage X is calculated by surrounding a square region. At this time, an area (C) of the region is set so as to become 24,000 to 26,000 pixels. A sum (D) of an area of regions in which the inorganic fine particle (A) (for example, silica) does not exist is calculated, by automatic binarization by “processing”—binarization.

The coverage is obtained from the area C of the square region and the sum D of areas of the regions in which the inorganic fine particle (A) does not exist, according to the following Expression:

$$\\ Coverage ( \% ) = 100 - ( D / C \times 100 ) .$$

An average value of all the obtained data is defined as the coverage.

### Evaluation Index for Degree of Dispersion of Silica Aggregated Particle on Surface of Toner Particle

The evaluation index for degree of dispersion of the silica aggregated particle on the surface of the toner particle is calculated with the use of the scanning electron microscope “S-4800”. The toner to which the silica aggregated particle is externally added has been observed in a visual field magnified 10000 times at an acceleration voltage of 1.0 kV in the same visual field. The evaluation index for degree of dispersion has been calculated from the observed image in the following way, with the use of an image processing software “ImageJ”.

Binarization has been performed so that only the silica aggregated particle is extracted, centers of gravity coordinates have been calculated with respect to n pieces of external additives and all external additives, and a distance dn min between each silica aggregated particle and the nearest silica aggregated particle has been calculated. When the average value of the closest distances between the external additives in the image is represented by dave, a degree of dispersion is represented by the following Expression.

$$\\ Evaluation index for degree of dispersion = \sqrt{\frac{{\sum }_{1}^{n} {( dn min - d ave )}^{2}}{n}} / d ave$$

The degree of dispersions of 50 toners which have been randomly observed have been determined according to the above procedure, and the average value has been defined as the evaluation index for degree of dispersion.

### Method for Measuring Maximum Feret's Diameter and Aspect Ratio of Titanium Oxide Particle

The maximum Feret's diameter and the aspect ratio of the titanium oxide particle are measured in the same way as in the above measurement method of the primary particle size based on number, the maximum Feret's diameter and the aspect ratio of the silica aggregated particle.

Furthermore, it can be determined whether or not the external additive is titanium oxide, by combination with elemental analysis by an energy dispersive X-ray spectrometry (EDS). Specifically, the toner is observed in a field of view magnified up to 100,000 times with the use of a scanning electron microscope “S-4800” (trade name; manufactured by Hitachi, Ltd.). The surface of the toner particle is focused, and the external additive to be discriminated is observed. The external additive to be discriminated is subjected to EDS analysis, and it can be known whether or not the external additive is titanium oxide, from the element peak.

### Method for Measuring Average Circularity of Toner

The average circularity of the toner particles has been measured with a flow-type particle image analysis apparatus “FPIA-3000” (manufactured by Sysmex Corporation) under the measurement and analysis conditions at the time of calibration work.

The specific measurement method is as follows. First, approximately 20 ml of ion-exchanged water from which impure solids and the like have been removed in advance is charged into a container made from glass. Into the container, approximately 0.2 ml of a diluted liquid is added that has been prepared by diluting “Contaminon N” (aqueous solution of 10% by mass of neutral detergent having pH 7 for cleaning precision measuring instruments, which is formed of a nonionic surface-active agent, an anionic surface-active agent and an organic builder, produced by Fujifilm Wako Pure Chemical Corporation) with ion-exchanged water to approximately 3 times by mass, as a dispersing agent. Furthermore, approximately 0.02 g of a measurement sample is added, and the mixture is subjected to dispersion treatment for 2 minutes with the use of an ultrasonic dispersion instrument; and the product is determined to be a dispersion for measurement. At this time, the dispersion is appropriately cooled so that the temperature thereof becomes from 10° C. to 40° C. As the ultrasonic dispersion instrument, a desktop type of ultrasonic cleaner dispersion instrument (for example, “VS-150” (manufactured by Velvo-Clear Co., Ltd.)) is used of which the oscillation frequency is 50 kHz and the electric output is 150 W; and a predetermined amount of ion-exchanged water is charged into a water tank, and approximately 2 ml of the Contaminon N is added into the water tank.

For the measurement, the flow-type particle image analysis apparatus was used which was equipped with “LUCPLFLN” (magnification of 20 times, and numerical aperture of 0.40) as an objective lens, and a particle sheath “PSE-900A” (produced by Sysmex Corporation) was used as a sheath liquid. The dispersion prepared according to the procedure is introduced into the flow-type particle image analysis apparatus, and 2000 toner particles are measured in an HPF measurement mode and a total count mode. Then, a binarization threshold value at the time of the particle analysis was set to 85%, the diameter of the particle to be analyzed was limited to a circle-equivalent diameter of from 1.977 μm to 39.54 μm, and the average circularity of the toner particle was determined. In the measurement, automatic focus adjustment is performed with the use of standard latex particles (for example, “RESEARCH AND TESTPARTICLES Latex Microsphere Suspensions 5100A” produced by Duke Scientific Corporation, which is diluted with ion-exchanged water) before the start of the measurement. After that, it is preferable to perform focus adjustment every two hours from the start of the measurement.

For information, in the Examples of the present application, the flow-type particle image analysis apparatus was used which was calibrated by Sysmex Corporation and obtained a calibration certificate issued by Sysmex Corporation. The measurement was performed under the measurement and analysis conditions at the time when the calibration certificate was issued, except that the diameter of the particle to be analyzed was limited to a circle-equivalent diameter of from 1.977 to 39.54 μm.

### Method for Measuring Thickness T of Shell Layer Existing on Surface of Toner Particle

The portion is determined to be the shell layer, which does not contain a crystalline material in a region of 25% or shorter of a distance between the outline of the toner cross section and the centroid of the toner cross section, from the outline. The cross sections of 100 or more toners were observed, and an average value of the distances from the outline to the region which did not contain the crystalline material was calculated; and the value was determined to be the thickness of the shell layer.

### Determination of Presence or Absence of Dodecylbenzenesulfonic Acid or Dodecylbenzenesulfonate in Toner

The presence or absence of the dodecylbenzenesulfonic acid or the dodecylbenzenesulfonate is determined by performing analysis by the MS/MS (mass mass) method with the use of a tandem mass spectrometer which is directly connected to a liquid chromatograph ESI/MS analysis apparatus.

The MS/MS method is a mass spectrometry method that measures a fragment which has been taken out in a first analysis system, by a second analysis system, thereby can detect a fragment having a further small molecular weight, and can easily analyze the structure of a sample.

Elution conditions A: At 25° C., methanol (JISK8891 standard equivalent) in an amount of 10 times based on mass for the toner is used, and the mixture is stirred for 10 hours with the number of rotations of a rotor of 200 rpm by a stirring apparatus.

Centrifugal separation conditions A: The rotation is performed for 30 minutes at 25° C., with a rotation radius of 10.1 cm, and with the number of rotations of 3500 rpm.

The sample is prepared with the use of a toner under the above elution conditions A, and the sample is separated into a solid content and a supernatant liquid under the above centrifugal separation conditions A.

The supernatant obtained by the above adjustment is supplied to the following measuring apparatus, and is analyzed by a liquid chromatograph ESI/MS under the following analysis conditions B. The mass spectrum of an anion is obtained, and it is checked that the peak is detected at m/z=325. In addition, the ion detected as the peak existing at m/z=325 is supplied as a precursor ion to the tandem mass spectrometer, and an MS/MS spectrum is obtained under the analysis conditions B.
Measuring apparatus: Ultimate3000 (manufactured by Thermo Fisher Scientific Inc.)
Mass spectrometer: LCQ Fleet (manufactured by Thermo Fisher Scientific Inc.)

Analysis conditions B: to detect ions which have been ionized under the conditions of capillary voltage: −35 V and tube lens voltage: −110 V under the following conditions, as anions, to select the ion detected at m/z=325 as a precursor ion, and to detect an ion which has been dissociated by collision-induced dissociation against an inert gas: He with a collision energy: 35 eV.
Ionization technique: electrospray method (ESI)
Sheath Gas: 10 (arb. unit.)
Aux Gas: 5 (arb. unit.)
Spray voltage: 5 kV
Capillary temperature: 275° C.
Moving phase: methanol (product corresponding with JISK8891 standard)
Column: unused (Stationary phase is not used.)
Flow rate: 1 ml/min
Injection volume: 10 μl
Chromatogram detector: UV detector
MS acquisition time period: 5 min
MS measurement range: 50 to 1500 m/z
Collision inert gas: He (helium)
Collision energy: 35 eV

### Method for Measuring Molecular Weight of Polyester Resin

A molecular weight of a polyester resin is measured by gel permeation chromatography (GPC) in the following way.

Firstly, the polyester resin is dissolved in tetrahydrofuran (THF) at room temperature. Then, the obtained solution is filtered through a solvent-resistant membrane filter “Maeshori disc” (manufactured by Tosoh Corporation) having a pore diameter of 0.2 μm, and a sample solution is obtained. For information, the sample solution is adjusted so that the concentration of the components soluble in THF becomes 0.8% by mass. The sample solution is subjected to the measurement under the following conditions.
Apparatus: high-speed GPC apparatus “HLC-8220GPC” [manufactured by Tosoh Corporation]
Column: duplicate of LF-604
Eluent: THF
Flow rate: 0.6 ml/min
Oven temperature: 40° C.
Sample injection volume: 0.020 ml

When the molecular weight of the sample is calculated, the molecular weight calibration curve is used which has been prepared by use of standard polystyrene resins (for example, trade name “TSK standard polystyrene F-850, F-450, F-288, F-128, F-80, F-40, F-20, F-10, F-4, F-2, F-1, A-5000, A-2500, A-1000 and A-500”, produced by Tosoh Corporation).

### Acid Value of Polyester Resin

An acid value is the number of mg of potassium hydroxide required to neutralize an acid contained in 1 g of a sample.

The acid value in the present invention is measured according to JIS K0070-1992, and specifically, is measured according to the following procedure.

The sample is subjected to a titration which uses an ethyl alcohol solution of 0.1 mol/l potassium hydroxide (produced by Kishida Chemical Co., Ltd.). A factor of the above ethyl alcohol solution of potassium hydroxide can be determined with the use of a potentiometric titration apparatus (potentiometric titration measuring apparatus AT-510, manufactured by Kyoto Electronics Manufacturing Co., Ltd.). The factor is determined from the amount of the above ethyl alcohol solution of potassium hydroxide required for neutralization at the time when 100 ml of 0.100 mol/l hydrochloric acid is placed in a 250 ml tall beaker, and is titrated with the above ethyl alcohol solution of potassium hydroxide. The above 0.100 mol/l hydrochloric acid which is used is prepared according to JIS K8001-1998.

The measurement conditions for the acid value are shown below.
Titration apparatus: potentiometric titration apparatus AT-510 (manufactured by Kyoto Electronics Manufacturing Co., Ltd.)
Electrodes: composite glass electrode double-junction type (manufactured by Kyoto Electronics Manufacturing Co. Ltd.)
Control software for titration apparatus: AT-WIN
Titration analysis software: Tview
The titration parameter and control parameter in the titration are performed in the following way.
Titration parameter
Titration mode: blank titration
Titration mode: whole volume titration
Maximum titration amount: 20 ml
Waiting time period before titration: 30 seconds
Titration direction: automatic
Control parameter
End point determination potential: 30 dE
Potential value of end point determination: 50 dE/dmL
End point detection determination: not set
Control speed mode: standard
Gain: 1
Data collection potential: 4 mV
Data collection titration amount: 0.1 ml

Actual test: 0.100 g of a measurement sample is precisely weighed in a 250 ml tall beaker, and 150 ml of a mixed solution of toluene/ethanol (3:1) is added thereto; and the measurement sample is dissolved therein over 1 hour. The resultant measurement sample is titrated with the above ethyl alcohol solution of potassium hydroxide with the use of the above potentiometric titration apparatus.

Blank test: titration is performed in the same way as in the above operation, except that the sample is not used (in other words, only a mixed solution of toluene/ethanol (3:1) is used). The obtained result is substituted into the following Expression, and the acid value is calculated.

$$\\ A = [ ( C - B ) \times f \times 5.611 ] / S$$

(wherein A: acid value (mgKOH/g), B: amount (ml) of ethyl alcohol solution of potassium hydroxide to be added in the blank test, C: amount (ml) of ethyl alcohol solution of potassium hydroxide to be added in the actual test, f: factor of potassium hydroxide solution, and S: sample (g).)

### Method for Calculating Thickness of Shell of Core-Shell Structure

In the method for calculating the number of microdomains and the number-average particle size of the major axes, in a region of 25% or shorter of the distance between the outline of the toner cross section and the centroid of the toner cross section, from the outline of the cross section of the crystalline material of the toner, a portion which does not contain the crystalline material is defined as a shell. The cross sections of 100 or more toners were observed, and an average value of the distances from the outline to the region which did not contain the crystalline material was calculated; and the value was determined to be the thickness of the shell.

### Measurement of Weight-Average Particle Size (D4) of Toner

The weight-average particle size (D4) of the toner is calculated by operations of: using a precision particle size distribution measuring apparatus “Coulter Counter Multisizer 3” (registered trade mark, manufactured by Beckman Coulter, Inc.) which is equipped with an aperture tube of 100 μm and based on a pore electric resistance method, and an attached dedicated software “Beckman Coulter Multisizer 3 Version 3.51” (manufactured by Beckman Coulter, Inc.) for setting the measurement conditions and analyzing the measured data; measuring a particle size distribution through effective measurement channels of 25000 channels; and analyzing the measured data.

As an aqueous electrolyte solution to be used for the measurement, for example, “ISOTON II” (produced by Beckman Coulter, Inc.) can be used in which special-grade sodium chloride is dissolved in ion-exchanged water so that the concentration becomes about 1% by mass.

Note that before the measurement and analysis, the dedicated software is set in the following way.

In the “change standard measurement method (SOM)” screen of the dedicated software, the total count number of a control mode is set to 50,000 particles, the number of times of measurement is set to 1 and a value obtained by using standard particles each having a particle diameter of 10.0 μm (manufactured by Beckman Coulter, Inc.) is set as a Kd value. A threshold and a noise level are automatically set by pressing a threshold/noise level measurement button. In addition, a current is set to 1,600 μA, a gain is set to 2, an electrolyte solution is set to ISOTON II (product name) and a check mark is placed in a check box as to whether the aperture tube is flushed after the measurement.

In the “setting for conversion from pulse to particle diameter” screen of the dedicated software, a bin interval is set to a logarithmic particle diameter, the number of particle diameter bins is set to 256 and a particle diameter range is set to the range of from 2 to 60 μm.

A specific measurement method is as described below.
1. 200 mL of the electrolyte aqueous solution is charged into a 250 mL round-bottom beaker made of glass dedicated for the Multisizer 3. The beaker is set in a sample stand and the electrolyte aqueous solution in the beaker is stirred with a stirrer rod at 24 rotations/see in a counterclockwise direction. Then, dirt and bubbles in the aperture are removed by the “aperture tube flush” function of the analysis software.
2. 30 mL of the electrolyte aqueous solution is charged into a 100 mL flat-bottom beaker made of glass. 0.3 mL of a diluted solution prepared by diluting Contaminon N (a 10% by mass aqueous solution of a pH7 precision measuring device cleaning neutral detergent comprising a non-ionic surfactant, an anionic surfactant and an organic builder, manufactured by Wako Pure Chemical Industries, Ltd.) with ion-exchanged water by three mass fold is added to the electrolyte aqueous solution.
3. A predetermined amount of ion-exchanged water and 2 mL of Contaminon N (product name) are added into the water tank of an ultrasonic dispersing unit (product name: Ultrasonic Dispersion System Tetra 150, manufactured by Nikkaki Bios Co., Ltd.) having an electrical output of 120 W in which two oscillators each having an oscillatory frequency of 50 kHz are built so as to be under the state of being out of phase by 180º.
4. The beaker in the section (2) is set in the beaker fixing hole of the ultrasonic dispersing unit and the ultrasonic dispersing unit is operated. Then, the height position of the beaker is adjusted in order that the liquid surface of the electrolyte aqueous solution in the beaker may resonate with an ultrasonic wave from the ultrasonic dispersing unit to the fullest extent possible.
5. 10 mg of the toner is gradually added to and dispersed in the electrolyte aqueous solution in the beaker in the section (4) under a state in which the electrolyte aqueous solution is irradiated with the ultrasonic wave. Then, the ultrasonic dispersion treatment is continued for an additional 60 seconds. The temperature of water in the water tank is appropriately adjusted to from 10 to 40° C. in the ultrasonic dispersion.
6. The electrolyte aqueous solution in the section (5) in which the toner has been dispersed is added dropwise with a pipette to the round-bottom beaker in the section (1) placed in the sample stand and the concentration of the particles to be measured is adjusted to 5%. Then, measurement is performed until the particle diameters of 50,000 particles are measured.
7. The measurement data is analyzed with the dedicated software included with the apparatus and the weight-average particle diameter (D4) is calculated. An “average diameter” on the “analysis/volume statistics (arithmetic average)” screen of the dedicated software when the dedicated software is set to show a graph in a vol % unit is the weight-average particle diameter (D4).

### EXAMPLES

The present invention will be described in more detail below with reference to Examples and Comparative Examples, but the present invention is not limited thereto at all. Parts which are used in formulations of Examples are based on mass unless otherwise specified.
the thickness of the shell.

### Production Example of Silica Aggregated Particle 1

Into a mixing chamber of a combustion burner, 60 kg/h of silicon tetrachloride (SiCl4), 50 m³/h (standard condition) of hydrogen (primary combustible gas) and 33 m³/h (standard condition) of oxygen (primary oxygen-containing gas) were introduced and mixed; this mixed gas was injected from the burner, was ignited and combusted in a reaction chamber, and was allowed to remain in the mixing chamber for 0.001 seconds; and then furthermore, 20 m³/h (standard state) of hydrogen (primary combustible gas) and 30 m³/h (standard state) of oxygen (primary oxygen-containing gas) were additionally supplied thereto, and was allowed to remain there for 0.020 seconds. The generated silica powder was collected with a filter.

The obtained original substance particle of silica (BET specific surface area: 15.4 m²/g) in the amount of 100 parts was placed in a reaction container, and such a solution that 1 part of hexamethyldisilazane was diluted with 100 parts of hexane was added to the original substance particles which were stirred under a nitrogen purge; and in such a state that stirring was continued, the resultant mixture was subjected to treatment at a reaction temperature and for a reaction time period which were shown in treatment conditions, and a silica aggregated particle 1 was obtained.

In the obtained silica aggregated particle 1, the primary particle size based on number was 30 nm, the maximum Feret's diameter was 290 nm, the aspect ratio was 2.10, and the silanol amount defined by the Expression (1) was 0.15. The physical properties of the silica aggregated particle 1 are shown in Tables 1-1 to 1-3.

### Production Example of Silica Aggregated Particles 2 to 16

Silica aggregated particles 2 to 16 were produced in the same way as in the production method of the silica aggregated particle 1, except that in the production example of the silica aggregated particle 1, the production example of original substance particle of silica (flow rate of silicon tetrachloride, flow rate of hydrogen gas, flow rate of oxygen gas, silica concentration, and staying time period) and the surface treatment conditions of silica aggregated particle (type and amount of addition of surface treatment agent, reaction temperature, and reaction time period) were changed as described in Tables 1-1 to 1-3. The physical properties of silica aggregated particles 2 to 16 are shown in Tables 1-1 to 1-3.

TABLE 1-1

| | Manufacturing condition of original substance of silica aggregated particle | | | | | | | | BET specific |
|---|---|---|---|---|---|---|---|---|---|
| | Flame hydrolysis step | | | | | Aggregation step | | | surface area |
| | Silicon | Hydrogen | Oxygen | Silica | Staying | Hydrogen | Oxygen | Staying | of silica |
| | tetrachloride | gas | gas | concentration | time | gas | gas | time | substance |
| | [kg/hr] | [Nm³/hr] | [Nm³/hr | [kg/Nm³] | [sec] | [Nm³/hr] | [Nm³/hr] | [sec] | [m²/g] |
| Silica aggregated particle 1 | 60 | 50 | 33 | 0.22 | 0.001 | 20 | 30 | 0.020 | 15.4 |
| Silica aggregated particle 2 | 60 | 50 | 33 | 0.22 | 0.001 | 20 | 30 | 0.020 | 15.4 |
| Silica aggregated particle 3 | 60 | 50 | 33 | 0.22 | 0.001 | 20 | 30 | 0.020 | 15.4 |
| Silica aggregated particle 4 | 60 | 50 | 33 | 0.22 | 0.001 | 20 | 30 | 0.020 | 15.4 |
| Silica aggregated particle 5 | 60 | 50 | 33 | 0.22 | 0.001 | 20 | 30 | 0.020 | 15.4 |
| Silica aggregated particle 6 | 60 | 50 | 33 | 0.22 | 0.001 | 20 | 30 | 0.020 | 15.4 |
| Silica aggregated particle 7 | 50 | 50 | 50 | 0.11 | 0.001 | 20 | 30 | 0.010 | 50.0 |
| Silica aggregated particle 8 | 150 | 50 | 25 | 0.69 | 0.001 | 20 | 30 | 0.030 | 10.6 |
| Silica aggregated particle 9 | 60 | 50 | 33 | 0.22 | 0.001 | 20 | 30 | 0.008 | 61.0 |
| Silica aggregated particle 10 | 60 | 50 | 33 | 0.22 | 0.001 | 20 | 30 | 0.035 | 6.8 |
| Silica aggregated particle 11 | 50 | 50 | 50 | 0.11 | 0.001 | 20 | 30 | 0.003 | 61.8 |
| Silica aggregated particle 12 | 60 | 50 | 33 | 0.22 | 0.001 | 20 | 30 | 0.040 | 5.7 |
| Silica aggregated particle 13 | 180 | 40 | 25 | 0.73 | 0.001 | 20 | 30 | 0.005 | 21.1 |
| Silica aggregated particle 14 | 60 | 10 | 73 | 0.22 | 0.001 | 20 | 30 | 0.020 | 15.0 |
| Silica aggregated particle 15 | 180 | 40 | 25 | 0.73 | 0.001 | 20 | 30 | 0.002 | 66.2 |
| Silica aggregated particle 16 | 60 | 50 | 33 | 0.22 | 0.001 | 20 | 30 | 0.045 | 4.8 |

TABLE 1-2

| | Surface treatment condition of silica aggregated particle | | | | | | |
|---|---|---|---|---|---|---|---|
| | Type of surface treatment agent | | | | | | |
| | | R1 of | R2 of | m of | | Reaction | Reaction |
| | | formula | formula | formula | Number | temperature | time |
| | Compound name | (A) | (A) | (A) | of parts | [° C.] | [minutes] |
| Silica aggregated particle 1 | Hexamethyldisilazane | — | — | — | 1.0 | 200 | 30 |
| Silica aggregated particle 2 | Polydimethylsiloxane | Hydroxy group | Hydroxy group | 50 | 3.0 | 300 | 30 |
| | represented by structural | | | | | | |
| | formula (A) | | | | | | |
| Silica aggregated particle 3 | Polydimethylsiloxane | Epoxy group | Epoxy group | 50 | 3.0 | 300 | 30 |
| | represented by structural | | | | | | |
| | formula (A) | | | | | | |
| Silica aggregated particle 4 | Polydimethylsiloxane | Carbinol group | Carbinol group | 50 | 3.0 | 300 | 30 |
| | represented by structural | | | | | | |
| | formula (A) | | | | | | |
| Silica aggregated particle 5 | Polydimethylsiloxane | Hydroxy group | Hydroxy group | 50 | 5.0 | 300 | 30 |
| | represented by structural | | | | | | |
| | formula (A) | | | | | | |
| Silica aggregated particle 6 | Polydimethylsiloxane | Hydroxy group | Hydroxy group | 50 | 1.0 | 300 | 30 |
| | represented by structural | | | | | | |
| | formula (A) | | | | | | |
| Silica aggregated particle 7 | Hexamethyldisilazane | — | — | — | 0.5 | 200 | 30 |
| Silica aggregated particle 8 | Hexamethyldisilazane | — | — | — | 0.1 | 200 | 30 |
| Silica aggregated particle 9 | Hexamethyldisilazane | — | — | — | 0.5 | 200 | 30 |
| Silica aggregated particle 10 | Hexamethyldisilazane | — | — | — | 0.1 | 200 | 30 |
| Silica aggregated particle 11 | Hexamethyldisilazane | — | — | — | 0.5 | 200 | 30 |
| Silica aggregated particle 12 | Hexamethyldisilazane | — | — | — | 0.1 | 200 | 30 |
| Silica aggregated particle 13 | Hexamethyldisilazane | — | — | — | 0.5 | 200 | 30 |
| Silica aggregated particle 14 | Hexamethyldisilazane | — | — | — | 1.0 | 200 | 30 |
| Silica aggregated particle 15 | Hexamethyldisilazane | — | — | — | 0.5 | 200 | 30 |
| Silica aggregated particle 16 | Hexamethyldisilazane | — | — | — | 0.1 | 200 | 30 |

TABLE 1-3

| | Physical property of silica aggregated particle | | | |
|---|---|---|---|---|
| | Primary | | | Amount of |
| | particle | Maximum | | silanol |
| | size based | Feret's | | defined by |
| | on number | diameter | Aspect | Expression |
| | [nm] | [nm] | ratio | (1) |
| Silica aggregated particle 1 | 30 | 290 | 2.10 | 0.15 |
| Silica aggregated particle 2 | 31 | 286 | 2.24 | 0.10 |
| Silica aggregated particle 3 | 34 | 272 | 2.31 | 0.09 |
| Silica aggregated particle 4 | 30 | 293 | 2.25 | 0.14 |
| Silica aggregated particle 5 | 32 | 301 | 2.02 | 0.07 |
| Silica aggregated particle 6 | 31 | 281 | 2.31 | 0.15 |
| Silica aggregated particle 7 | 25 | 124 | 1.75 | 0.17 |
| Silica aggregated particle 8 | 62 | 386 | 3.84 | 0.18 |
| Silica aggregated particle 9 | 32 | 115 | 1.53 | 0.17 |
| Silica aggregated particle 10 | 30 | 489 | 3.96 | 0.20 |
| Silica aggregated particle 11 | 20 | 118 | 1.38 | 0.20 |
| Silica aggregated particle 12 | 32 | 485 | 4.17 | 0.20 |
| Silica aggregated particle 13 | 120 | 256 | 1.28 | 0.20 |
| Silica aggregated particle 14 | 31 | 293 | 2.21 | 0.98 |
| Silica aggregated particle 15 | 22 | 100 | 1.51 | 0.20 |
| Silica aggregated particle 16 | 30 | 505 | 3.86 | 0.20 |

### Production Example of Titanium Oxide Particles 1 to 5

A titanium oxide particle was produced in the following way. To metatitanic acid obtained by a sulfate method, an aqueous solution of 50%-NaOH was added in an amount of 4 times the molar amount of TiO₂ as NaOH, and the mixture was heated at 95° C. for 2 hours. The resultant mixture was thoroughly washed, 31%-HCl was added to the mixture so that HCl/TiO₂ becomes 0.26, and the mixture was heated at the boiling point for 1 hour. After having been cooled, the resultant mixture was neutralized with 1 mol/L-NaOH to pH 7, then, the resultant liquid was washed and dried, and a fine particle titanium oxide was produced. A specific surface area of the obtained fine particle titanium oxide was 115 g/m².

To 100 parts of the fine particle titanium oxide, 100 parts of NaCl and 25 parts of Na₂P₂O₇. 10H₂O were added, the mixture was mixed for 1 hour with a vibrating ball-mill, and the mixture was calcined for 2 hours at 850° C. in an electric oven. The obtained calcined product was charged into pure water; and the mixture was heated therein at 80° C. for 6 hours, and then was washed to remove a soluble salt therefrom. All the particles obtained by drying were fine particle titanium oxide particles 1 to 5 of which minor axes were in a range of from 0.03 to 0.07 μm, and major axes were in a range of from 0.4 to 0.8 μm. The physical properties of titanium oxide particles 1˜5 are shown in Table 2.

TABLE 2

| | Physical property of titanium oxide particle | |
|---|---|---|
| | Maximum Feret's diameter [nm] | Aspect ratio |
| Titanium oxide particle 1 | 1121 | 7.20 |
| Titanium oxide particle 2 | 843 | 5.11 |
| Titanium oxide particle 3 | 2867 | 6.52 |
| Titanium oxide particle 4 | 976 | 4.83 |
| Titanium oxide particle 5 | 3142 | 6.71 |

### Production Example of Polyester Resin 1

The following materials were mixed in a reaction tank equipped with a nitrogen introduction line, a dehydration line, and a stirrer; and 100 parts of the mixture and 0.52 parts of tin di(2-ethylhexanoate) of a catalyst were charged into a polymerization tank.
Terephthalic acid 45.0 parts
Ethylene oxide adduct of bisphenol A 53.0 parts

Subsequently, the atmosphere in the polymerization tank was replaced with nitrogen, and then, the mixture was subjected to a polycondensation reaction over 6 hours while the mixture was heated at 200° C. Furthermore, after the temperature was raised to 210° C., 2.0 parts of trimellitic anhydride was added; and the pressure in the polymerization tank was reduced to 40 kPa, and then a condensation reaction was further performed. In the obtained polyester resin, an acid value was 6.0 mgKOH/g and a weight-average molecular weight (Mw) was 12400.

### Production Example of Styrene Acrylic Resin 1

The following materials were mixed in a reaction tank equipped with a cooling tube, a stirrer and a nitrogen induction tube, and the mixture was kept at 180° C. while being heated and stirred.
Styrene 77.0 parts
n-Butyl acrylate 21.0 parts
Acrylic acid 2.0 parts
Xylene 300.0 parts

Subsequently, 50.0 parts of a xylene solution of 2.0% by mass of t-butyl hydroperoxide was continuously added dropwise to the system over 4.5 hours, and after cooling, the solvent (xylene) was separated and removed; and thus, styrene acrylic resin 1 was synthesized. In the obtained styrene acrylic resin, a weight-average molecular weight Mw was 14,500 and a Tg was 65° C.

“Preparation of resin particle dispersion 1”
Styrene acrylic resin 1 100 parts
Methyl ethyl ketone 50 parts
Isopropyl alcohol 20 parts

Methyl ethyl ketone and isopropyl alcohol were charged into a container. After that, the above resin was gradually charged and completely dissolved by stirring, and a solution of a styrene acrylic resin 1 was obtained.

The container containing the solution of the styrene acrylic resin 1 was set to 65° C., and while the solution was stirred, an aqueous solution of 10% ammonium was gradually added dropwise so that the total amount became 5 parts; and furthermore, 230 parts of ion-exchanged water was gradually added dropwise thereto at a rate of 10 ml/min, and the styrene acrylic resin 1 was phase-inversion emulsified. Furthermore, a solvent was removed by pressure reduction of the emulsified liquid with an evaporator, and a resin particle dispersion 1 of the styrene acrylic resin 1 was obtained. A volume-average particle size of the resin particles was 135 nm. In addition, the solid content of the resin particle was adjusted to 20% with ion-exchanged water.

“Preparation of resin particle dispersion 2”
Polyester resin 1 100 parts
Methyl ethyl ketone 50 parts
Isopropyl alcohol 20 parts

Methyl ethyl ketone and isopropyl alcohol were charged into a container. After that, the above materials were gradually charged into the container, and were completely dissolved by stirring; and a solution of the polyester resin 1 was obtained. The container containing the solution of the polyester resin 1 was set to 40° C., and while the solution was stirred, an aqueous solution of 10% ammonium was gradually added dropwise so that the total amount became 3.5 parts; and furthermore, 230 parts of ion-exchanged water was gradually added dropwise thereto at a rate of 10 ml/min, and the polyester resin 1 was phase-inversion emulsified. Furthermore, a solvent was removed by pressure reduction of the emulsified liquid, and a resin particle dispersion 2 of the polyester resin 1 was obtained. The volume-average particle size of the resin particles was 155 nm. In addition, the solid content of the resin particle was adjusted to 20% with ion-exchanged water.

“Preparation of coloring-agent particle dispersion”
Copper phthalocyanine (Pigment Blue 15:3) 45 parts
Ionic surface-active agent NEOGEN RK (produced by Dai-ichi Kogyo Seiyaku Co., Ltd.) 5 parts
Ion-exchanged water 190 parts

The above components were mixed and dispersed for 10 minutes with the use of a homogenizer (Ultra-Turrax® manufactured by IKA-Werke), and then the mixture was subjected to dispersion treatment for 20 minutes at a pressure of 250 MPa with the use of an Ultimizer (counter-impingement type wet grinder: manufactured by Sugino Machine Limited); and a coloring-agent particle dispersion was obtained of which the volume-average particle size of coloring-agent particles was 120 nm and the solid content was 20%.

“Preparation of release agent particle dispersion”
Release agent (hydrocarbon wax, and melting temperature: 79° C.) 15 parts
Ionic surface-active agent NEOGEN RK (produced by Dai-ichi Kogyo Seiyaku Co., Ltd.) 2 parts
Ion-exchanged water 240 parts

The above materials were heated to 100° C., were thoroughly dispersed with the use of Ultra-Turrax® T50 manufactured by IKA-Werke, and then the mixture was heated to 115° C. with the use of a pressure discharge type Gorlin homogenizer and was subjected to dispersion treatment for 1 hour; and a release agent particle dispersion was obtained of which the volume-average particle size was 160 nm and the solid content was 20%.

### Production Example of Toner Particle 1

Resin particle dispersion 1 900 parts
Coloring-agent particle dispersion 50 parts
Release agent particle dispersion 80 parts

Firstly, as a core forming step, each of the above materials was charged into a round bottom flask made from stainless steel, and was mixed with the other. Subsequently, the mixture was dispersed with the use of a homogenizer Ultra-Turrax® T50 (manufactured by IKA-Werke), at 5000 r/min for 10 minutes. An aqueous solution of 1.0% nitric acid was added thereto, and a pH of the resultant mixture was adjusted to 3.0; and the resultant mixture was heated to 58° C. in a heating water bath, while such a number of rotations was appropriately adjusted that the mixed liquid was stirred with the use of a stirring blade. A volume-average particle size of the formed aggregated particles was appropriately checked with the use of a Coulter Multisizer III; when aggregated particles (cores) having a volume-average particle size of 5.0 μm were formed, the following materials were each charged thereto as the shell layer forming step, and the mixture was further stirred for 1 hour; and a shell layer was formed.
Resin Particle Dispersion 2 40 parts
Ion-exchanged water 300 parts
Aqueous solution of 10.0% by mass of borax 19 parts
(Borax; sodium tetraborate decahydrate produced by Fuji Film Wako Pure Chemical Corporation)

After that, the pH was adjusted to 9.0 with the use of an aqueous solution of 5% sodium hydroxide, and the mixture was heated to 89° C. while stirring was continued. When a desired surface shape was obtained, heating was stopped; and the mixture was cooled to 25° C., was subjected to filtration and solid-liquid separation, and then washed with ion-exchanged water. After the completion of washing, the washed product was dried with the use of a vacuum dryer, and toner particles were obtained of which the weight-average particle size (D4) was 6.3 μm.

Furthermore, an aqueous solution of 1% sodium dodecylbenzenesulfonate (product name: NEOGEN RK (produced by Dai-ichi Kogyo Seiyaku Co., Ltd.)) was sprayed so that a content of dodecylbenzenesulfonic acid in the toner became 500 ppm, and the toner particle 1 was obtained.

### Production Examples of Toner Particles 2 to 11, and 13

Toner particles 2 to 11 and 13 were obtained by the same method as in the production example of the toner particle 1, except that the formulation and conditions were changed to those shown in Table 3. The physical properties of the obtained toner particles 2 to 11 and 13 are shown in Table 3.

### Production Example of Toner Particle 12

### Production of Toner Base Particle

The following materials were adequately mixed with an FM mixer (manufactured by Nippon Coke & Engineering Co., Ltd.), and then were melted and kneaded with a twin-screw kneader (manufactured by Ikegai Corp.) which was set at a temperature of 100° C.
Styrene acrylic resin 1 95.0 parts
Polyester resin 1 5.0 parts
HNP9 (melting temperature: 76° C., and produced by Nippon Seiro Co., Ltd.) 5.0 parts
C. I. Pigment Blue15:3 6.0 parts

The obtained kneaded product was cooled, and was coarsely pulverized to 1 mm or smaller by a hammermill; and a coarsely pulverized product was obtained.

Next, the obtained coarsely pulverized product was pulverized into a finely pulverized product of about 5 μm with the use of a turbo mill manufactured by Freund-Turbo Corporation, and then furthermore, the fine coarse powder was cut with the use of a multi-division classifier which utilizes the Coanda effect; and a toner base particle 1 was obtained. A weight-average particle size (D4) of the toner base particles 1 was 6.8 μm, and a Tg was 58° C.

### Production of Toner Base Particle Dispersion

Into a reaction container containing 390.0 parts of ion-exchanged water, 15.0 parts of sodium phosphate (dodecahydrate) was charged, and the container was kept warm at 65° C. for 1.0 hour while nitrogen purge was conducted.

The solution was stirred at 12000 rpm with the use of a T. K. homomixer (manufactured by Tokushu Kika Kogyo Co., Ltd.). While the stirring was maintained, such an aqueous solution of calcium chloride that 9.0 parts of calcium chloride (dihydrate) was dissolved in 10.0 parts of ion-exchanged water was charged into a reaction container all at once, and an aqueous medium was prepared which contained the inorganic fine particle as a dispersing agent. Furthermore, 1.0 mol/L of hydrochloric acid was charged to the aqueous medium in the reaction container, the pH was adjusted to 6.0, and an aqueous medium 1 was prepared.

Into the aqueous medium 1, 200.0 parts of the toner base particle 1 was charged, and was dispersed therein at a temperature of 40° C. for 30 minutes while the mixture was rotated at 7000 rpm with the use of the T. K. homomixer. Ion-exchanged water was added to the mixture, and the resultant mixture was adjusted so that the concentration of the toner base particle in the dispersion became 20.0%; and a toner base particle dispersion 1 was obtained.

### Production of Toner Particle

The following samples were weighed in a reaction container and were mixed with the use of a propeller stirring blade.
Toner base particle dispersion 1 500.0 parts
Resin Particle Dispersion 2 10.0 parts

Next, a pH of the obtained mixed liquid was adjusted to 4.0 with the use of an aqueous solution of 1 mol/L of NaOH, and the temperature of the mixed liquid was raised to 30° C.; and then, 1.5 parts of a boric acid powder was added, and the mixture was held for 1.0 hour while being mixed at a 200 rpm with the use of a propeller stirring blade. After that, the temperature was raised to 80° C. at a rate of 1° C./min while the mixed liquid was stirred with a propeller stirring blade, and the temperature was kept for 2 hours.

Subsequently, a temperature of the contents was cooled to room temperature (approximately 25° C.), a pH of the contents was adjusted to 1.5 with 1 mol/L of hydrochloric acid; and the resultant liquid was stirred for 1.0 hour, then was filtered while being washed with ion-exchanged water, and thereby, a toner particle 12 was obtained. The physical properties of the obtained toner particle 12 are shown in Table 3.

### Production Example of Toner Particle 14

Toner particle 14 was obtained by the same method as in the production example of the toner particle 12, except that the formulation and conditions were changed to those shown in Table 3. The physical properties of the obtained toner particle 14 are shown in Table 3.

TABLE 3

| | | Shell layer forming step | | | | | |
|---|---|---|---|---|---|---|---|
| | | | | Resin particle dispersion liquid for | | Presence or absence of | |
| | Toner | Boric acid component | | shell | | dodecylbenzenesulfonate | Weight average |
| Toner | manufacturing | | Amount added | | Amount added | or | particle size |
| particle | method | Type | [parts by mass] | Type | [parts by mass] | dodecylbenzenesulfonate | (D4) [μm] |
| Toner | Emulsion | 10.0 mass % borax | 15.0 | Resin particle | 40.0 | Presence | 6.3 |
| particle 1 | aggregation | aqueous solution | | dispersion 2 | | | |
| | method | | | | | | |
| Toner | Emulsion | 10.0 mass % borax | 30.0 | Resin particle | 40.0 | Presence | 6.5 |
| particle 2 | aggregation | aqueous solution | | dispersion 2 | | | |
| | method | | | | | | |
| Toner | Emulsion | 10.0 mass % borax | 10.0 | Resin particle | 40.0 | Presence | 6.4 |
| particle 3 | aggregation | aqueous solution | | dispersion 2 | | | |
| | method | | | | | | |
| Toner | Emulsion | 10.0 mass % borax | 5.0 | Resin particle | 40.0 | Presence | 6.2 |
| particle 4 | aggregation | aqueous solution | | dispersion 2 | | | |
| | method | | | | | | |
| Toner | Emulsion | 10.0 mass % borax | 58.0 | Resin particle | 40.0 | Presence | 6.8 |
| particle 5 | aggregation | aqueous solution | | dispersion 2 | | | |
| | method | | | | | | |
| Toner | Emulsion | 10.0 mass % borax | 4.0 | Resin particle | 40.0 | Presence | 6.7 |
| particle 6 | aggregation | aqueous solution | | dispersion 2 | | | |
| | method | | | | | | |
| Toner | Emulsion | 10.0 mass % borax | 4.0 | Resin particle | 20.0 | Presence | 6.2 |
| particle 7 | aggregation | aqueous solution | | dispersion 2 | | | |
| | method | | | | | | |
| Toner | Emulsion | 10.0 mass % borax | 4.0 | Resin particle | 50.0 | Presence | 6.3 |
| particle 8 | aggregation | aqueous solution | | dispersion 2 | | | |
| | method | | | | | | |
| Toner | Emulsion | 10.0 mass % borax | 4.0 | Resin particle | 18.0 | Presence | 6.6 |
| particle 9 | aggregation | aqueous solution | | dispersion 2 | | | |
| | method | | | | | | |
| Toner | Emulsion | 10.0 mass % borax | 4.0 | Resin particle | 52.0 | Presence | 6.4 |
| particle 10 | aggregation | aqueous solution | | dispersion 2 | | | |
| | method | | | | | | |
| Toner | Emulsion | 10.0 mass % borax | 4.0 | Resin particle | 52.0 | Absence | 6.2 |
| particle 11 | aggregation | aqueous solution | | dispersion 2 | | | |
| | method | | | | | | |
| Toner | Pulverization | Boric acid powder | 1.5 | Resin particle | 10.0 | Absence | 6.8 |
| particle 12 | method | | | dispersion 2 | | | |
| Toner | Emulsion | — | 0.0 | Resin particle | 40.0 | Presence | 6.5 |
| particle 13 | aggregation | | | dispersion 2 | | | |
| | method | | | | | | |
| Toner | Pulverization | — | 0.0 | Resin particle | 10.0 | Absence | 6.6 |
| particle 14 | method | | | dispersion 2 | | | |

### Production Example of Toner 1

An FM mixer (FM500, manufactured by Nippon Coke & Engineering Co., Ltd.) was charged with 100.0 parts of the toner particle 1, 0.7 parts of the silica aggregated particle 1, and 0.2 parts of the titanium oxide particle 1. After that, the mixture was subjected to the external addition of mixing the mixture at 800 rpm for 10 minutes.

At this time, simultaneously with the start of mixing, warm water and cold water were appropriately passed through a jacket, and the temperature in the tank was kept at 45° C.

After that, the toner was sieved with a mesh having an opening of 75 μm and a toner 1 was obtained. The physical properties of the toner 1 are shown in Tables 5-1 to 5-4.

### Production Examples of Toner Particles 2 to 31

Toners 2 to 31 were obtained by the same operation as in the production example of the toner 1 except that a type of toner particle, a type and an amount of addition of silica aggregated particle, and a type and an amount of addition of titanium oxide particle were changed as shown in Tables 4-1 and 4-2. The physical properties of the toner 2 to 31 are shown in Tables 5-1 to 5-4.

TABLE 4-1

| | | | | | | Condition of external | |
|---|---|---|---|---|---|---|---|
| | | Material of external addition | | | | addition | |
| | | | Amount of silica | | Addition of titanium | | Rotation |
| | | Type of silica | aggregated particle added | Type of titanium | oxide particle [parts | Time | number |
| | Toner particle | aggregated particle | [parts by mass] | oxide particle | by mass] | [minutes] | [rpm] |
| Toner 1 | Toner particle 1 | Silica aggregated | 0.7 | Titanium oxide | 0.2 | 10 | 800 |
| | | particle 1 | | particle 1 | | | |
| Toner 2 | Toner particle 1 | Silica aggregated | 0.7 | Titanium oxide | 0.2 | 10 | 800 |
| | | particle 2 | | particle 1 | | | |
| Toner 3 | Toner particle 1 | Silica aggregated | 0.7 | Titanium oxide | 0.2 | 10 | 800 |
| | | particle 3 | | particle 1 | | | |
| Toner 4 | Toner particle 1 | Silica aggregated | 0.7 | Titanium oxide | 0.2 | 10 | 800 |
| | | particle 4 | | particle 1 | | | |
| Toner 5 | Toner particle 2 | Silica aggregated | 0.7 | Titanium oxide | 0.2 | 10 | 800 |
| | | particle 5 | | particle 1 | | | |
| Toner 6 | Toner particle 3 | Silica aggregated | 0.7 | Titanium oxide | 0.2 | 10 | 800 |
| | | particle 6 | | particle 1 | | | |
| Toner 7 | Toner particle 4 | Silica aggregated | 0.7 | Titanium oxide | 0.2 | 10 | 800 |
| | | particle 6 | | particle 1 | | | |
| Toner 8 | Toner particle 5 | Silica aggregated | 0.7 | Titanium oxide | 0.2 | 10 | 800 |
| | | particle 5 | | particle 1 | | | |
| Toner 9 | Toner particle 4 | Silica aggregated | 1.4 | Titanium oxide | 0.2 | 10 | 800 |
| | | particle 6 | | particle 1 | | | |
| Toner 10 | Toner particle 4 | Silica aggregated | 0.1 | Titanium oxide | 0.2 | 10 | 800 |
| | | particle 6 | | particle 1 | | | |
| Toner 11 | Toner particle 4 | Silica aggregated | 1.4 | Titanium oxide | 0.2 | 10 | 800 |
| | | particle 7 | | particle 1 | | | |
| Toner 12 | Toner particle 4 | Silica aggregated | 0.1 | Titanium oxide | 0.2 | 10 | 800 |
| | | particle 8 | | particle 1 | | | |
| Toner 13 | Toner particle 4 | Silica aggregated | 1.4 | Titanium oxide | 0.2 | 10 | 800 |
| | | particle 9 | | particle 1 | | | |
| Toner 14 | Toner particle 5 | Silica aggregated | 0.1 | Titanium oxide | 0.2 | 10 | 800 |
| | | particle 10 | | particle 1 | | | |
| Toner 15 | Toner particle 6 | Silica aggregated | 1.4 | Titanium oxide | 0.2 | 5 | 800 |
| | | particle 9 | | particle 1 | | | |
| Toner 16 | Toner particle 6 | Silica aggregated | 1.4 | Titanium oxide | 0.2 | 15 | 800 |
| | | particle 9 | | particle 1 | | | |
| Toner 17 | Toner particle 6 | Silica aggregated | 1.5 | Titanium oxide | 0.2 | 10 | 800 |
| | | particle 9 | | particle 2 | | | |

TABLE 4-2

| | | | | | | Condition of external | |
|---|---|---|---|---|---|---|---|
| | | Material of external addition | | | | addition | |
| | | | Amount of silica | | Addition of titanium | | Rotation |
| | | Type of silica | aggregated particle added | Type of titanium | oxide particle [parts | Time | number |
| | Toner particle | aggregated particle | [parts by mass] | oxide particle | by mass] | [minutes] | [rpm] |
| Toner 18 | Toner particle 6 | Silica aggregated | 1.5 | Titanium oxide | 0.2 | 10 | 800 |
| | | particle 9 | | particle 3 | | | |
| Toner 19 | Toner particle 7 | Silica aggregated | 1.5 | Titanium oxide | 0.2 | 10 | 800 |
| | | particle 9 | | particle 4 | | | |
| Toner 20 | Toner particle 8 | Silica aggregated | 1.5 | Titanium oxide | 0.2 | 10 | 800 |
| | | particle 9 | | particle 5 | | | |
| Toner 21 | Toner particle 9 | Silica aggregated | 1.5 | Titanium oxide | 0.2 | 10 | 800 |
| | | particle 9 | | particle 4 | | | |
| Toner 22 | Toner particle 10 | Silica aggregated | 1.5 | Titanium oxide | 0.2 | 10 | 800 |
| | | particle 9 | | particle 4 | | | |
| Toner 23 | Toner particle 11 | Silica aggregated | 1.5 | Titanium oxide | 0.2 | 10 | 800 |
| | | particle 9 | | particle 4 | | | |
| Toner 24 | Toner particle 11 | Silica aggregated | 1.5 | — | — | 10 | 800 |
| | | particle 9 | | | | | |
| Toner 25 | Toner particle 12 | Silica aggregated | 1.5 | — | — | 10 | 800 |
| | | particle 9 | | | | | |
| Toner 26 | Toner particle 4 | Silica aggregated | 1.4 | Titanium oxide | 0.2 | 10 | 800 |
| | | particle 11 | | particle 1 | | | |
| Toner 27 | Toner particle 5 | Silica aggregated | 0.1 | Titanium oxide | 0.2 | 10 | 800 |
| | | particle 12 | | particle 1 | | | |
| Toner 28 | Toner particle 4 | Silica aggregated | 0.7 | Titanium oxide | 0.2 | 10 | 800 |
| | | particle 13 | | particle 1 | | | |
| Toner 29 | Toner particle 4 | Silica aggregated | 0.7 | Titanium oxide | 0.2 | 10 | 800 |
| | | particle 14 | | particle 1 | | | |
| Toner 30 | Toner particle 4 | Silica aggregated | 1.4 | Titanium oxide | 0.2 | 10 | 800 |
| | | particle 15 | | particle 1 | | | |
| Toner 31 | Toner particle 5 | Silica aggregated | 0.1 | Titanium oxide | 0.2 | 10 | 800 |
| | | particle 16 | | particle 1 | | | |
| Toner 32 | Toner particle 13 | Silica aggregated | 1.4 | Titanium oxide | 0.2 | 10 | 800 |
| | | particle 7 | | particle 1 | | | |
| Toner 33 | Toner particle 14 | Silica aggregated | 1.4 | Titanium oxide | 0.2 | 10 | 800 |
| | | particle 7 | | particle 1 | | | |

TABLE 5-1

| | Toner properties | | | | | | | |
|---|---|---|---|---|---|---|---|---|
| | | Boron atom and | | | | | | Presence or |
| | Weight | presence or | Boron atomic | Coverage of | | | | absence of |
| | average | absence of | weight on the | silica | Dispersion | | | dodecylbenzene- |
| | particle | fragment peak | surface of the | agglomerate | index of silica | Average | Shell layer | sulfonic acid or |
| | diameter | derived from BO | toner particles | d particles | agglomerated | circular | thickness | dodecylbenzene- |
| | [μm] | structure | [ppm] | [%] | particles | shape | [nm] | sulfonate |
| Toner 1 | 6.3 | Presence | 0.700 | 2.0 | 0.80 | 0.971 | 421 | Presence |
| Toner 2 | 6.3 | Presence | 0.700 | 2.6 | 0.80 | 0.971 | 421 | Presence |
| Toner 3 | 6.3 | Presence | 0.700 | 2.1 | 0.80 | 0.971 | 421 | Presence |
| Toner 4 | 6.3 | Presence | 0.700 | 2.3 | 0.80 | 0.971 | 421 | Presence |
| Toner 5 | 6.5 | Presence | 1.500 | 2.6 | 0.90 | 0.971 | 421 | Presence |
| Toner 6 | 6.4 | Presence | 0.050 | 2.1 | 0.80 | 0.968 | 421 | Presence |
| Toner 7 | 6.2 | Presence | 0.010 | 2.3 | 0.80 | 0.965 | 371 | Presence |
| Toner 8 | 6.8 | Presence | 2.00 | 2.2 | 0.90 | 0.972 | 498 | Presence |
| Toner 9 | 6.2 | Presence | 0.010 | 9.8 | 0.30 | 0.965 | 498 | Presence |
| Toner 10 | 6.2 | Presence | 0.010 | 0.5 | 1.70 | 0.965 | 498 | Presence |
| Toner 11 | 6.2 | Presence | 0.010 | 9.8 | 0.30 | 0.965 | 498 | Presence |
| Toner 12 | 6.2 | Presence | 0.010 | 0.5 | 1.90 | 0.965 | 498 | Presence |
| Toner 13 | 6.2 | Presence | 0.010 | 9.7 | 0.20 | 0.965 | 371 | Presence |
| Toner 14 | 6.8 | Presence | 2.00 | 0.4 | 2.00 | 0.965 | 498 | Presence |
| Toner 15 | 6.7 | Presence | 0.008 | 9.6 | 0.40 | 0.965 | 356 | Presence |
| Toner 16 | 6.7 | Presence | 0.008 | 9.5 | 0.20 | 0.965 | 356 | Presence |
| Toner 17 | 6.7 | Presence | 0.008 | 10.5 | 0.30 | 0.973 | 572 | Presence |

TABLE 5-2

| | Physical property of silica aggregated particle | | | | | Physical property of | |
|---|---|---|---|---|---|---|---|
| | Primary | | | | | titanium oxide particle | |
| | particle | Maximum | | | | Maximum | |
| | size based | Feret's | | Silanol amount | | Feret's | |
| | on number | diameter | Aspect | S defined by | | diameter | Aspect |
| | [nm] | [nm] | ratio | expression (1) | S/B | [nm] | ratio |
| Toner 1 | 30 | 290 | 2.10 | 0.15 | 0.21 | 1100 | 7.20 |
| Toner 2 | 31 | 286 | 2.24 | 0.10 | 0.14 | 1100 | 7.20 |
| Toner 3 | 34 | 272 | 2.31 | 0.09 | 0.13 | 1100 | 7.20 |
| Toner 4 | 30 | 293 | 2.25 | 0.14 | 0.20 | 1100 | 7.20 |
| Toner 5 | 32 | 301 | 2.02 | 0.07 | 0.05 | 1100 | 7.20 |
| Toner 6 | 31 | 281 | 2.31 | 0.15 | 3.00 | 1100 | 7.20 |
| Toner 7 | 32 | 301 | 2.02 | 0.15 | 15.0 | 1100 | 7.20 |
| Toner 8 | 30 | 293 | 2.25 | 0.07 | 0.035 | 1100 | 7.20 |
| Toner 9 | 30 | 320 | 2.38 | 0.15 | 15.0 | 1100 | 7.20 |
| Toner 10 | 32 | 316 | 2.12 | 0.15 | 15.0 | 1100 | 7.20 |
| Toner 11 | 25 | 124 | 1.75 | 0.17 | 17.0 | 1100 | 7.20 |
| Toner 12 | 62 | 386 | 3.84 | 0.18 | 18.0 | 1100 | 7.20 |
| Toner 13 | 32 | 115 | 1.53 | 0.17 | 17.0 | 1100 | 7.20 |
| Toner 14 | 30 | 489 | 3.96 | 0.20 | 0.10 | 1100 | 7.20 |
| Toner 15 | 32 | 115 | 1.53 | 0.17 | 21.3 | 1100 | 7.20 |
| Toner 16 | 35 | 114 | 1.53 | 0.17 | 21.3 | 1100 | 7.20 |
| Toner 17 | 25 | 114 | 1.53 | 0.18 | 22.5 | 840 | 5.10 |

TABLE 5-3

| | Toner properties | | | | | | | |
|---|---|---|---|---|---|---|---|---|
| | | Boron atom and | | | | | | Presence or |
| | Weight | presence or | Boron atomic | Coverage of | | | | absence of |
| | average | absence of | weight on the | silica | Dispersion | | | dodecylbenzene- |
| | particle | fragment peak | surface of the | agglomerate | index of silica | Average | Shell layer | sulfonic acid or |
| | diameter | derived from BO | toner particles | d particles | agglomerated | circular | thickness | dodecylbenzene- |
| | [μm] | structure | [ppm] | [%] | particles | shape | [nm] | sulfonate |
| Toner 18 | 6.7 | Presence | 0.008 | 10.5 | 0.30 | 0.973 | 572 | Presence |
| Toner 19 | 6.2 | Presence | 0.008 | 10.5 | 0.30 | 0.973 | 303 | Presence |
| Toner 20 | 6.3 | Presence | 0.008 | 10.5 | 0.30 | 0.973 | 689 | Presence |
| Toner 21 | 6.6 | Presence | 0.008 | 10.5 | 0.30 | 0.973 | 287 | Presence |
| Toner 22 | 6.4 | Presence | 0.008 | 10.5 | 0.30 | 0.973 | 718 | Presence |
| Toner 23 | 6.2 | Presence | 0.008 | 10.5 | 0.30 | 0.973 | 718 | Absence |
| Toner 24 | 6.2 | Presence | 0.008 | 10.5 | 0.26 | 0.973 | 718 | Absence |
| Toner 25 | 6.8 | Presence | 2.10 | 10.6 | 0.67 | 0.951 | 790 | Absence |
| Toner 26 | 6.2 | Presence | 0.010 | 9.6 | 0.28 | 0.963 | 371 | Presence |
| Toner 27 | 6.8 | Presence | 2.00 | 0.6 | 1.89 | 0.966 | 498 | Presence |
| Toner 28 | 6.2 | Presence | 0.010 | 2.6 | 0.24 | 0.964 | 498 | Presence |
| Toner 29 | 6.2 | Presence | 0.010 | 2.6 | 0.24 | 0.961 | 498 | Presence |
| Toner 30 | 6.3 | Presence | 0.010 | 9.8 | 0.26 | 0.962 | 372 | Presence |
| Toner 31 | 6.7 | Presence | 2.00 | 0.5 | 1.95 | 0.963 | 496 | Presence |
| Toner 32 | 6.5 | Absence | 0.00 | 9.6 | 0.82 | 0.962 | 498 | Presence |
| Toner 33 | 6.6 | Absence | 0.00 | 9.7 | 0.83 | 0.957 | 498 | Absence |

TABLE 5-4

| | Physical property of silica aggregated particle | | | | | Physical property of | |
|---|---|---|---|---|---|---|---|
| | Primary | | | | | titanium oxide particle | |
| | particle | Maximum | | | | Maximum | |
| | size based | Feret's | | Silanol amount | | Feret's | |
| | on number | diameter | Aspect | S defined by | | diameter | Aspect |
| | [nm] | [nm] | ratio | expression (1) | S/B | [nm] | ratio |
| Toner 18 | 25 | 114 | 1.53 | 0.18 | 22.5 | 2860 | 6.50 |
| Toner 19 | 25 | 114 | 1.53 | 0.18 | 22.5 | 976 | 4.83 |
| Toner 20 | 25 | 114 | 1.53 | 0.18 | 22.5 | 3140 | 6.71 |
| Toner 21 | 25 | 114 | 1.53 | 0.18 | 22.5 | 976 | 4.83 |
| Toner 22 | 25 | 114 | 1.53 | 0.18 | 22.5 | 969 | 4.79 |
| Toner 23 | 25 | 114 | 1.53 | 0.18 | 22.5 | 978 | 4.65 |
| Toner 24 | 25 | 114 | 1.53 | 0.18 | 22.5 | — | — |
| Toner 25 | 25 | 114 | 1.53 | 0.18 | 0.086 | — | — |
| Toner 26 | 20 | 100 | 1.38 | 0.20 | 20.0 | 1100 | 7.20 |
| Toner 27 | 32 | 512 | 4.17 | 0.20 | 0.10 | 1100 | 7.20 |
| Toner 28 | 120 | 120 | 1.10 | 0.20 | 20.0 | 1100 | 7.20 |
| Toner 29 | 31 | 293 | 2.21 | 0.98 | 98.0 | 1100 | 7.20 |
| Toner 30 | 22 | 100 | 1.51 | 0.20 | 20.0 | 1100 | 7.20 |
| Toner 31 | 30 | 505 | 3.86 | 0.20 | 0.10 | 1100 | 7.20 |
| Toner 32 | 32 | 126 | 1.89 | 0.17 | 0.00 | 1100 | 7.20 |
| Toner 33 | 32 | 131 | 1.94 | 0.16 | 0.00 | 1100 | 7.20 |

### Example 1

The following evaluations were performed with the use of the above toner 1. The evaluation results are shown in Table 6-1.

A modified machine of a commercially available laser beam printer “LBP7600C” manufactured by Canon Marketing Japan Inc. was used. The modification was made by changing the gears and software of the main body of the evaluation machine, and thereby, the number of rotations of the conveying roller was set so that the roller rotates at an equal speed with respect to the drum. Due to the modification being made as described above, the transfer of the toner from the photoreceptor to the recording medium is suppressed, and the mode becomes more severe in evaluation of a level of the transfer dropout.

Next, an electrophotographic apparatus and a process cartridge were left to stand in an environment of 15° C. and 10% RH for 48 hours, for the purpose of being acclimated to the measurement environment. After the standing, under the same low-temperature and low-humidity environment (15° C./10% RH), an image was printed out which had a margin of 50 mm on each of the left and right sides, and a printing rate of 4.0% in the central portion, on 20000 sheets of Business4200 paper of letter size (produced by XEROX, and 75 g/m²) in the lateral direction; and the initial image and the image after the durable printing of 20000 sheets were evaluated.

### Evaluation of Image Density

The image density was measured by measuring a relative density to an image of a white background portion having an image density of 0.00, with the use of “Macbeth Sales Company Densitometer RD918” (manufactured by GretagMacbeth AG) according to the attached instruction manual; and the obtained relative density was used as a value of the image density.

The initial density and the density after the above durable printing were measured. The durable developability was evaluated by a degree of decrease from a density in the initial stage to a density after the durable printing. Three solid images were output each at the initial stage and after the durable printing, and an average value of densities at the center was evaluated as the image density. The evaluation criteria are as follows, and C or higher was determined to be satisfactory.

### Initial Image Density

A: Image density is 1.45 or more.
B: Image density is from 1.40 to 1.45
C: Image density is from 1.35 to 1.40
D: Image density is lower than 1.35

### Image Density Decreasing Rate

The image density decreasing rate was calculated with the use of the following Expression.

Image density decreasing rate=(Initial image density−Image density after durable printing)/Initial image density×100
A: The decreasing rate of the image density is lower than 5.0%
B: The decreasing rate of the image density is from 5.0 to 10.0%.
C: The decreasing rate of the image density is from 10.0 to 15.0%
D: The decreasing rate of the image density is 15.0% or higher.

### Evaluation of Fogging

The fogging was measured by measurement of reflectance with the use of REFLECTMETE®MODEL TC-6DS manufactured by TokyoDenshoku Co., Ltd. A green filter was used as the filter. The fogging was calculated from reflectances before and after the output of the solid white image with the use of the following Expression.

Fogging (reflectance) (%)=reflectance of standard paper (%)−reflectance of solid white image sample (%)

The fogging after the above durable printing was measured. After the durable printing, three solid white images were output, and an average value of foggings at the center was evaluated as the fogging. The evaluation criteria are as follows, and C or higher was determined to be satisfactory.
A: lower than 1.0%
B: from 1.0 to 2.0%
C: from 2.0 to 3.0%
D: 3.0% or more

### Evaluation of Increasing Rate of Silica Aggregated Particle

The coverage of the silica aggregated particle at the initial stage and the coverage of the silica aggregated particle after the above durable printing were measured. The increasing rate of the silica aggregated particle was determined according to the degree of increase from the coverage of the silica aggregated particle in the initial stage to the coverage after the durable printing.

The increasing rate of the silica aggregated particle was calculated with the use of the following Expression.

Increasing rate of silica aggregated particle=(Coverage of silica aggregated particle after durable printing−Coverage of initial silica aggregated particle)/Coverage of initial silica aggregated particle×100

The evaluation criteria are as follows, and C or higher was determined to be satisfactory.
A: The increasing rate of silica aggregated particle is lower than 5.0%
B: The increasing rate of silica aggregated particle is from 5.0 to 10.0%
C: The increasing rate of silica aggregated particle is from 10.0 to 15.0%
D: The increasing rate of silica aggregated particle is 15.0% or higher.

### Evaluation of Transfer Dropout

The transfer dropout after the above durable printing was measured. The developing contrast is adjusted so that a toner loading on the paper is 0.6 mg/cm².

An image was formed so that thin lines existed in both the vertical and horizontal directions, and two 2-, 4-, 6-, 8- and 10-dot lines were printed so that the width of the non-latent image portion between each line became approximately 1 mm; and the results of visual observation and observation with a loupe having a magnification of 20 times were evaluated according to the following criteria. The evaluation criteria are as follows, and C or higher was determined to be satisfactory.
A: In the two-dot line, almost any dropout is not observed even by the magnification observation, and the dropout cannot be visually confirmed.
B: In the two-dot line, a small amount of dropouts is observed by magnification observation, but the dropout is not visually observed.
C: The dropout can be visually confirmed in the two-dot line, and cannot be visually confirmed in the four-dot line.
D: In the four-dot line, the dropout can be visually confirmed.

### Examples 2 to 25, and Comparative Examples 1 to 8

The above toners 2 to 33 were used and subjected to the above evaluations. The evaluation results are shown in Tables 6-1 and 6-2.

TABLE 6-1

| Example / | | Evaluation of durability in low-temperature and low-humidity environment | | | | |
|---|---|---|---|---|---|---|
| Comparative | | Initial image | Image density | | Increase rate of silica | Transfer |
| example | Toner | density | decreasing rate | Fogging | aggregated particle | dropout |
| Example 1 | Toner 1 | A | A | A | A | A |
| | | (1.48) | (3.1) | (0.4) | (3.2) | |
| Example 2 | Toner 2 | A | A | A | A | A |
| | | (1.47) | (3.4) | (0.3) | (3.4) | |
| Example 3 | Toner 3 | A | A | A | A | A |
| | | (1.46) | (3.6) | (0.2) | (3.6) | |
| Example 4 | Toner 4 | A | A | A | A | A |
| | | (1.48) | (3.8) | (0.4) | (3.8) | |
| Example 5 | Toner 5 | A | A | A | A | A |
| | | (1.47) | (3.7) | (0.5) | (4.1) | |
| Example 6 | Toner 6 | A | A | A | A | A |
| | | (1.45) | (3.2) | (0.4) | (3.6) | |
| Example 7 | Toner 7 | A | A | A | B | A |
| | | (1.46) | (3.1) | (0.4) | (6.1) | |
| Example 8 | Toner 8 | A | A | A | B | A |
| | | (1.48) | (3.6) | (0.8) | (6.4) | |
| Example 9 | Toner 9 | A | A | A | B | A |
| | | (1.46) | (3.8) | (0.3) | (6.2) | |
| Example 10 | Toner 10 | A | A | A | B | A |
| | | (1.45) | (3.7) | (0.5) | (6.5) | |
| Example 11 | Toner 11 | A | B | A | B | B |
| | | (1.47) | (5.2) | (0.7) | (6.4) | |
| Example 12 | Toner 12 | B | B | A | B | B |
| | | (1.41) | (6.3) | (0.8) | (8.8) | |
| Example 13 | Toner 13 | A | B | A | B | B |
| | | (1.48) | (9.2) | (0.7) | (6.3) | |
| Example 14 | Toner 14 | B | B | A | B | B |
| | | (1.42) | (9.6) | (0.9) | (9.5) | |
| Example 15 | Toner 15 | A | B | A | C | B |
| | | (1.46) | (9.4) | (0.7) | (11.1) | |
| Example 16 | Toner 16 | A | B | A | C | B |
| | | (1.45) | (9.3) | (0.6) | (11.4) | |
| Example 17 | Toner 17 | A | B | A | C | B |
| | | (1.46) | (9.6) | (0.7) | (12.5) | |

TABLE 6-2

| Example / | | Evaluation of durability in low-temperature and low-humidity environment | | | | |
|---|---|---|---|---|---|---|
| Comparative | | Initial image | Image density | | Increase rate of silica | Transfer |
| example | Toner | density | decreasing rate | Fogging | aggregated particle | dropout |
| Example 18 | Toner 18 | A | B | A | C | B |
| | | (1.48) | (9.8) | (0.7) | (12.8) | |
| Example 19 | Toner 19 | A | B | B | C | B |
| | | (1.47) | (9.9) | (1.4) | (12.7) | |
| Example 20 | Toner 20 | A | B | B | C | B |
| | | (1.46) | (8.5) | (1.8) | (12.9) | |
| Example 21 | Toner 21 | A | C | B | C | C |
| | | (1.45) | (10.3) | (1.7) | (12.6) | |
| Example 22 | Toner 22 | A | C | B | C | C |
| | | (1.46) | (10.4) | (1.6) | (12.5) | |
| Example 23 | Toner 23 | A | C | B | C | C |
| | | (1.47) | (10.6) | (1.5) | (13.5) | |
| Example 24 | Toner 24 | A | C | B | C | C |
| | | (1.48) | (11.8) | (1.8) | (14.6) | |
| Example 25 | Toner 25 | A | C | C | C | C |
| | | (1.47) | (13.1) | (2.4) | (14.9) | |
| Comparative | Toner 26 | A | C | B | D | D |
| example 1 | | (1.46) | (13.8) | (1.5) | (15.2) | |
| Comparative | Toner 27 | B | B | C | D | D |
| example 2 | | (1.40) | (9.8) | (2.5) | (16.7) | |
| Comparative | Toner 28 | A | C | C | D | D |
| example 3 | | (1.45) | (13.1) | (2.7) | (16.8) | |
| Comparative | Toner 29 | A | B | D | C | C |
| example 4 | | (1.45) | (9.7) | (4.2) | (14.8) | |
| Comparative | Toner 30 | A | C | B | D | D |
| example 5 | | (1.45) | (13.9) | (1.7) | (16.4) | |
| Comparative | Toner 31 | B | B | C | D | D |
| example 6 | | (1.40) | (9.8) | (2.7) | (17.8) | |
| Comparative | Toner 32 | A | B | B | D | D |
| example 7 | | (1.45) | (9.6) | (1.6) | (18.1) | |
| Comparative | Toner 33 | A | C | C | D | D |
| example 8 | | (1.47) | (14.5) | (2.8) | (19.6) | |

According to the present invention, a toner can be provided that is less likely to cause image defects due to the detachment of the silica aggregated particle even when having been used for a long period of time in a low-temperature and low-humidity environment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-010020, filed Jan. 26, 2023, which is hereby incorporated by reference herein in its entirety.

What is claimed is:

1. A toner comprising: a toner particle comprising a binder resin; and a silica aggregated particle, wherein,
in TOF-SIMS measurement of the toner particle, a fragment peak derived from a boron atom and a fragment peak derived from a boron-oxygen structure are detected;
the silica aggregated particle is an aggregated particle of silica fine particles having a primary particle size based on number of from 20 to 75 nm,
a maximum Feret's diameter of the silica aggregated particle is from 110 to 500 nm, and
an aspect ratio of the silica aggregated particle is from 1.50 to 4.00; and
when the silica aggregated particle is dispersed in a solvent and a titration operation is performed with the use of an aqueous solution of NaOH, the following Expression (1) is satisfied:
0.01≤[(a−b)×c×NA]/(d×e)≤0.20 (1),
(wherein a is a titration amount (L) of an aqueous solution of NaOH necessary for adjusting a mixed liquid of 25.0 g of ethanol and 75.0 g of an aqueous solution of 20% by mass of NaCl in which the silica aggregated particle is dispersed, to pH 9,
b is a titration amount (L) of the aqueous solution of NaOH necessary for adjusting a mixed liquid of 25.0 g of ethanol and 75.0 g of the aqueous solution of 20% by mass of NaCl, to pH 9,
c is a concentration (N) of the aqueous solution of NaOH used for the titration,
NA is Avogadro's number,
d is a mass (g) of the silica aggregated particle, and
e is a BET specific surface area (nm²/g) of the silica aggregated particle).

2. The toner according to claim 1, wherein an abundance (based on mass) of a boron atom in the toner measured by an inductively coupled plasma mass spectrometry apparatus (ICP-MS) is from 0.1 to 2.00 ppm.

3. The toner according to claim 1, wherein a coverage of the toner particle with the silica aggregated particle is from 0.5 to 10.0%.

4. The toner according to claim 1, wherein an evaluation index for degree of dispersion of the silica aggregated particle on a surface of the toner particle is 2.00 or smaller.

5. The toner according to claim 1, further comprising a titanium oxide particle that satisfies the following (i) and (ii), in addition to the silica aggregated particle:
(i) a maximum Feret's diameter is from 300 to 3000 nm; and
(ii) an aspect ratio is 5.0 or more.

6. The toner according to claim 1, wherein
when an abundance (based on mass) of a boron atom in the toner is represented by B (ppm), and an amount of silanol defined by the following Expression (2) is represented by S (pieces/nm²) at the time when the silica aggregated particle is dispersed in a solvent and a titration operation is performed with the use of the aqueous solution of NaOH, B and S satisfy the following Expression (3):
S=[(a−b)×c×NA]/(d×e) (2); and
0.03≤S/B≤20.0 (3)

7. The toner according to claim 1, wherein an average circularity of the toner is from 0.960 to 0.990.

8. The toner according to claim 1, wherein
the toner comprises a shell layer on a surface of the toner particle; and the shell layer existing on the surface of the toner particle comprises a polyester resin, the shell layer does not comprise a crystalline material in a cross section of the toner particle that is observed with a transmission electron microscope, and
when T (nm) represents a thickness of the shell layer, the following Expression (4) is satisfied:
300≤T≤700 (4).

9. The toner according to claim 1, wherein the toner particle comprises dodecylbenzenesulfonic acid or a dodecylbenzenesulfonate.
